(19) United States
(12) Patent Application Publication
(10) Pub. No.: US 2011/0044046 A1
(43) Pub. Date: Feb. 24, 2011

(54) HIGH BRIGHTNESS LIGHT SOURCE AND ILLUMINATION SYSTEM USING SAME

(76) Inventor: Nayef M. Abu-Ageel, Haverhill, MA (US)

Correspondence Address: MICHAEL K. LINDSEY;GAVRILOVICH, DODD & LINDSEY, LLP, 3303 N. SHOWDOWN PL., TUCSON, AZ, 85749, US

(21) Appl. No.: 12/764,861

(22) Filed: Apr. 21, 2010

Related U.S. Application Data
(60) Provisional application No. 61/171,450, filed on Apr. 21, 2009.

(51) Int. Cl. F21V 13/08; F21V 9/16; F21V 8/00

(52) U.S. Cl. 362/259

(57) ABSTRACT

One or more violet lasers and wavelength conversion materials, such as phosphor, are utilized to provide high efficiency light sources, illumination systems, projection systems and backlights that have no speckle at low cost. This solution bridges the gap that currently exists between lasers and light emitting diodes (LEDs) by providing a visible light source that has brightness higher than that of LEDs and lower than that of lasers.

This application claims benefit of U.S. Provisional Application No. 61/171,450, filed on Apr. 21, 2009.

### TECHNICAL FIELD

The disclosure relates generally to light sources, illumination systems, projection systems and backlights. More particularly, it relates to high brightness light sources, illumination systems, projection systems and backlights that utilize violet lasers and wavelength conversion materials such as phosphor.

### BACKGROUND

Lasers provide the most efficient use of light for etendue-limited applications. An example of such applications is miniature projectors that can be standalone or integrated into other electronic devices such as mobile phones and DVD players. In order to enhance their optical and electrical efficiencies, miniature projectors require light sources with brightness higher than that of light emitting diodes (LEDs) or lamps. Since miniature green lasers are not commercially available and blue lasers are expensive, miniature projector makers have been relying on LEDs as a light source. This results in miniature projectors with either low screen brightness or high electrical power consumption.

The prior art describes various light sources and illumination systems that utilize wavelength conversion to provide light at other wavelengths such as red, green and blue. For example, in U.S. Published Patent Application US2007/0189352), to Nagahama et al., describes a light emitting device 100 utilizing a wavelength conversion layer 30, as illustrated in FIG. 1A. The light emitting device 100 consists of a light source 10, a light guide 20, a light guide end member 47, an optional reflective film 80, a wavelength conversion member 30, a reflection member 60, and a shielding member 70. The light guide 20 transfers the light emitted from the light source 10, and guides the light to the wavelength conversion element 30. Some of this light is absorbed by element 30 and emitted at a converted wavelength. Reflective film 80 enhances the efficiency by reflecting excitation (source) light that was not absorbed back toward wavelength conversion element 30 and by also reflecting converted light toward the emission side of light emitting device 100. Reflection member 60 reflects at least part of the excitation light back toward the wavelength conversion member 30 in order to increase the light emitting efficiency. The shielding member 70 blocks the excitation light and transmits a light of a specific wavelength. In light emitting device 100, brightness of emitted light is limited. In addition, portions of source and converted light beams exit light emitting device 100 through the edges of wavelength conversion member 30, reflection member 60, shielding member 70 and reflective film 80, thus, resulting in light losses and lower optical efficiency. Furthermore, the reflectivity of reflective film 80 can be enhanced further, thus, reducing optical losses.

U.S. Pat. Nos. 7,040,774 and 7,497,581, to Beeson et al., propose illumination system 200, as shown in FIG. 1B. Illumination system 200 is comprised of a light emitting diode (LED) 116, a wavelength conversion layer 124 (e.g., phosphor), a light-recycling envelope 112 made from a reflective material (or having a reflective coating applied to its internal surfaces), an optional light guide 126, an optional optical element 125 (e.g., reflective polarizer or dichroic minor) and a light output aperture 114. The LED 116 has a light emitting layer 118 and a reflective layer 120. The light guide 126 transfers the light emitted from the light emitting layer 118 to the light-recycling envelope 112 through an opening 127 in the envelope 112. Part of the source light gets absorbed by wavelength conversion layer 124 and emitted at a second wavelength band. Recycling of the source light within the envelope 112 helps convert more of it into the second wavelength band. Some of the source light and converted light leave the envelope 112 through the opening 127 and get guided by the light guide 126 back toward the LED 116. The reflective layer 120 of LED 116 reflects part of the source light and converted light toward the envelope 112. Some of the light exiting through the output aperture 114 gets transmitted and the remainder gets reflected back toward the envelope 112 by optical element 125. This process continues until all the light within the envelope 112 is either transmitted through optical element 125, absorbed or lost. Illumination system 200 delivers light with enhanced brightness when compared to the brightness of the source and converted light beams. However, illumination system 200 is not efficient in light recycling due to the limited reflectivity of the LED 116 and limited reflectivity of the reflective layer applied to the interior surface of light-recycling envelope 112. Beeson et al. proposes in U.S. Pat. Nos. 7,040,774 and 7,497,581 the use of lasers and LEDs as light sources that can excite the wavelength conversion material enclosed within a light recycling envelope 112. However, these patents do not discuss or indicate the significant efficiency advantage that lasers have over LEDs in terms of providing light with high brightness (or low etendue) when utilized as an excitation source for a wavelength conversion material enclosed in a recycling envelope. Also, these patents fail to identify violet laser diodes (with peak emission at 405±10 nm) as a more efficient light source for excitation when compared to other laser diodes (e.g., blue or UV laser diodes) due to their high wall plug efficiency. In summary, U.S. Pat. Nos. 7,040,774 and 7,497,581 identify the wavelength range of 200-450 nm as the more preferable wavelength range of the light source that is used for excitation and do not specify the most suitable light source (within the 200-450 nm wavelength range) that can be used to generate high-brightness light with high wall plug efficiency.

U.S. Pat. No. 7,070,300, to Harbers et al., proposes illumination system 300 having a wavelength conversion element 212 that is physically separated from the light source 202 as shown in FIG. 1C. Illumination system 300 consists of a wavelength conversion element 212 (e.g., phosphor), a light source 202 (e.g., LED) mounted over an optional submount 204, which is in turn mounted on a heatsink 206, a first light collimator 208 to collimate light emitted from the light source, a color separation element 210, a second light collimator 214 to collimate light emitted from the wavelength conversion element 212, a first radiance enhancement structure 222 (e.g., a dichroic mirror or a diffractive optical element) mounted over the wavelength conversion element 212, a highly reflective substrate 215 mounted over a heatsink 216, a second radiance enhancement structure 218 (e.g., diffractive optical element, micro-refractive element, or brightness enhancement film) and a polarization recovery component 220. Light emitted from light source 202 is collimated by first light collimator 208 and directed toward the second light collimator 214 by color separation element 210. Second light collimator 214 concentrates a certain amount of this light on the wavelength conversion element 212, which in turn converts part of the source light into a light having a second wavelength band (i.e., converted light). This converted light gets collimated by the second light collimator 214 and transmitted by the color separation element 210 toward the second radiance enhancement structure 218, which in turn passes part of this light toward the polarization recovery component 220 and reflects the remainder toward the wavelength conversion element 212. The polarization recovery component 220 passes light with one polarization state and reflects the other state toward wavelength conversion element 212.

In U.S. Pat. No. 7,234,820, Harbers et al. proposes illumination system 400 having light collimators 375 and 381 having reflective apertures 390 and 391 for the purpose of enhancing the brightness of delivered light. As shown in FIG. 1D, illumination system 400 is comprised of a wavelength conversion element 374 (e.g., phosphor) mounted on a heatsink 376, a first fan 377, a light source 376 (e.g., LED) mounted on a heatsink 386, a second fan 387, a first light collimator 375 to collimate converted light emitted from the wavelength conversion element 374, a first reflective aperture 390 at the exit face of the first light collimator 375, a dichroic minor 382, a second light collimator 381 to collimate light emitted from the light source 376, a second reflective aperture 391 at the exit face of second light collimator 381, and light tunnel 384. Light emitted from light source 376 is collimated by first light collimator 381 and directed toward the second light collimator 375. Some of this light exits the second reflective aperture 391 and the remainder gets reflected back toward the light source 376. The second light collimator 375 concentrates the light received through its reflective aperture 390 on the wavelength conversion element 374, which in turn converts part of the source light into a light having a second wavelength band (i.e., converted light). This converted light gets collimated by the first light collimator 375 and part of it passes through the first reflective aperture 390 toward the dichroic mirror 382, which in turn reflects the converted light toward light tunnel 384.

Illumination systems 300 and 400 are not compact. In addition, these systems 300 and 400 are not efficient in light recycling due to the limited reflectivity of the reflective layers utilized in these systems 300 and 400, especially, the reflective coatings that are located directly below the wavelength conversion element 212 and 374. Therefore, systems with more compactness and enhanced recycling efficiency are needed in order to reduce light losses and improve the overall optical and electrical efficiencies.

### SUMMARY

Known wavelength conversion based illumination systems suffer from limited brightness, limited efficiency, high manufacturing cost, and/or limited compactness. Therefore, there is a need for bright, efficient and compact light sources and illumination systems that are capable of enabling miniature projection systems with smaller light valves (e.g., 0.15″-0.2″). In addition, there is a need for compact, light weight, efficient and cost-effective projection systems and backlights.

Disclosed herein are simple, low cost, compact and efficient light sources, illumination systems, projection systems and backlights utilizing violet lasers and wavelength conversion materials.

### BRIEF DESCRIPTION OF THE DRAWINGS

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIG. 1A is a cross-sectional view of a prior art illumination source.

FIG. 1B is a cross-sectional view of a prior art illumination system utilizing light recycling and a reflective envelope to provide light with enhanced brightness.

FIG. 1C is a cross-sectional view of a prior art illumination system utilizing remote phosphor for light conversion.

FIG. 1D is a cross-sectional view of a prior art illumination system utilizing remote phosphor and light recycling via a small output aperture to provide light with enhanced brightness.

FIG. 2A is a cross-sectional view of an illumination system utilizing a violet laser and wavelength conversion material. The input and output apertures are not aligned.

FIG. 2B is a cross-sectional view of an illumination system utilizing a violet laser and wavelength conversion material. The input and output apertures are aligned along the same axis.

FIG. 2C is a cross-sectional view of an illumination system utilizing a violet laser and wavelength conversion material. The violet laser is attached directly to the input aperture.

FIG. 2D is a cross-sectional view of an illumination system utilizing a violet laser, wavelength conversion material, and dichroic mirror that couples the violet laser light into the light envelope.

FIG. 2E shows a cross sectional view of a laser based illumination assembly 13.

FIG. 2F shows a cross sectional view of LED based illumination assembly 14.

FIG. 3A is a cross-sectional view of an illumination system with a single aperture and a reflective coating applied to the interior surface of a light envelope.

FIG. 3B is a cross-sectional view of an illumination system with single aperture and a reflective coating applied to the exterior surface of a light envelope.

FIG. 3C is a cross-sectional view of an illumination system with a single restricted aperture and a reflective coating applied to the interior surface of a light envelope.

FIG. 3D is a cross-sectional view of an illumination system with a single aperture, a reflective coating applied to the interior surface of a light envelope and collimation optics attached to its aperture.

FIG. 3E is a cross-sectional view of an illumination system with a restricted aperture, a reflective coating applied to the interior surface of a light envelope and a heat sink.

FIG. 3F is a cross-sectional view of an illumination system with a restricted aperture, a reflective coating applied to the exterior surface of a light envelope and a heat sink.

FIG. 3G is a cross-sectional view of an illumination system that has a dichroic coating with no dedicated input aperture. The laser light is inputted through the surface of the transparent envelope.

FIG. 3H is a cross-sectional view of an illumination system that has a dichroic coating with no dedicated input aperture. The LED light is inputted through the surface of the transparent envelope.

FIG. 4A is a cross-sectional view of an illumination system utilizing a hollow light envelope and a solid light guide with a reflective coating applied to parts of its entrance and exit faces.

FIG. 4B is a cross-sectional view of an illumination system utilizing a hollow light envelope and a tapered solid light guide with a reflective coating applied to parts of its sidewalls, its entrance face and exit face.

FIG. 5A is a cross-sectional view of an illumination system utilizing optical elements, three light envelopes and a transmissive deflector.

FIG. 5B is a top view of three light envelopes arranged in a line.

FIG. 5C is a top view of three light envelopes arranged so that their apertures are in close proximity.

FIG. 5D is a cross-sectional view of an illumination system utilizing optical elements, three light envelopes and a reflective deflector.

FIG. 5E is a cross-sectional view of an illumination system utilizing optical elements, three light envelopes and a reflective mirror-based deflector.

FIG. 6A is a detailed perspective view of a first collimating plate comprising micro-aperture, micro-guide and micro-lens arrays.

FIG. 6B is a cross-sectional view of the collimating plate of FIG. 6A.

FIG. 6C is a perspective view of the micro-guide and micro-lens arrays of the collimating plate of FIG. 6A.

FIG. 6D is a perspective view of the micro-aperture array of the collimating plate of FIG. 6A.

FIG. 7A is a perspective view of a second collimating plate comprising micro-aperture and micro-guide arrays.

FIG. 7B is a cross-sectional view of the collimating plate of FIG. 7A.

FIG. 8A is a top view of a third collimating plate comprising micro-aperture and micro-tunnel arrays.

FIG. 8B is a cross-sectional view of the collimating plate of FIG. 8A.

FIG. 9A is a perspective view of a fourth collimating plate comprising micro-aperture and micro-lens arrays.

FIG. 9B is an exploded view of the collimating plate of FIG. 9A.

FIG. 9C is a cross-sectional view of the collimating plate of FIG. 9A.

FIG. 10A is a cross-sectional view of an illumination system utilizing an illumination assembly and a projection lens.

FIG. 10B is a cross-sectional view of an illumination system utilizing multiple illumination assemblies and a lens.

FIG. 10C is a cross-sectional view of an illumination system utilizing multiple illumination assemblies and multiple transmissive micro-displays.

FIG. 10D is a cross-sectional view of an illumination system utilizing an illumination assembly, relay optics, a lens and a reflective micro-display.

FIG. 10E is a cross-sectional view of an illumination system utilizing an illumination assembly, relay lenses and a reflective micro-display.

FIG. 10F is a cross-sectional view of an illumination system utilizing an illumination assembly, a transmissive micro-display and a projection lens.

FIG. 10G shows a cross sectional view of an illumination assembly with angular color separation function. The dichroic mirrors are tilted.

FIG. 10H shows a cross sectional view of an illumination assembly with angular color separation function. The light sources or RGB beams are physically tilted.

FIG. 11A is a cross-sectional view of a 2D/3D illumination system utilizing an illumination assembly and two transmissive micro-displays.

FIG. 11B is a cross-sectional view of a 2D/3D illumination system utilizing an illumination assembly and two reflective micro-displays.

FIG. 12A is a top plan view of an edge-lit backlight apparatus for a direct-view display.

FIG. 12B is an exploded perspective side view of FIG. 12A.

FIG. 12C is a perspective view of a light guide plate.

FIG. 13A is a top plan view of an edge-lit backlight apparatus that utilizes angular color separation.

FIG. 13B shows a cross sectional view of a direct-view display system that utilizes angular color separation.

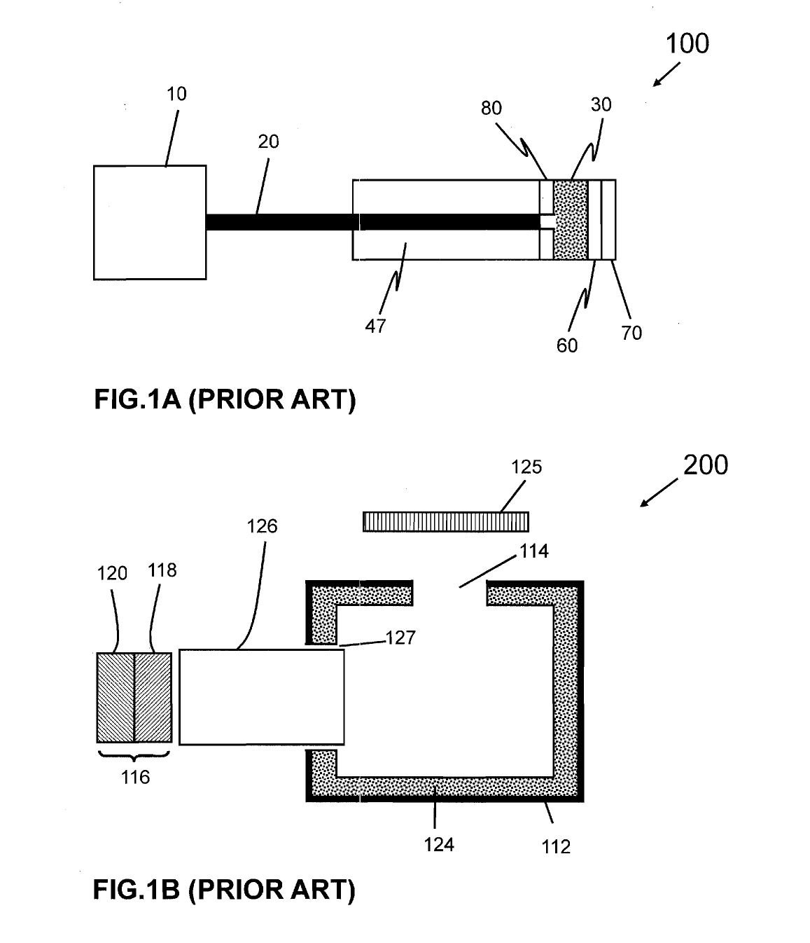

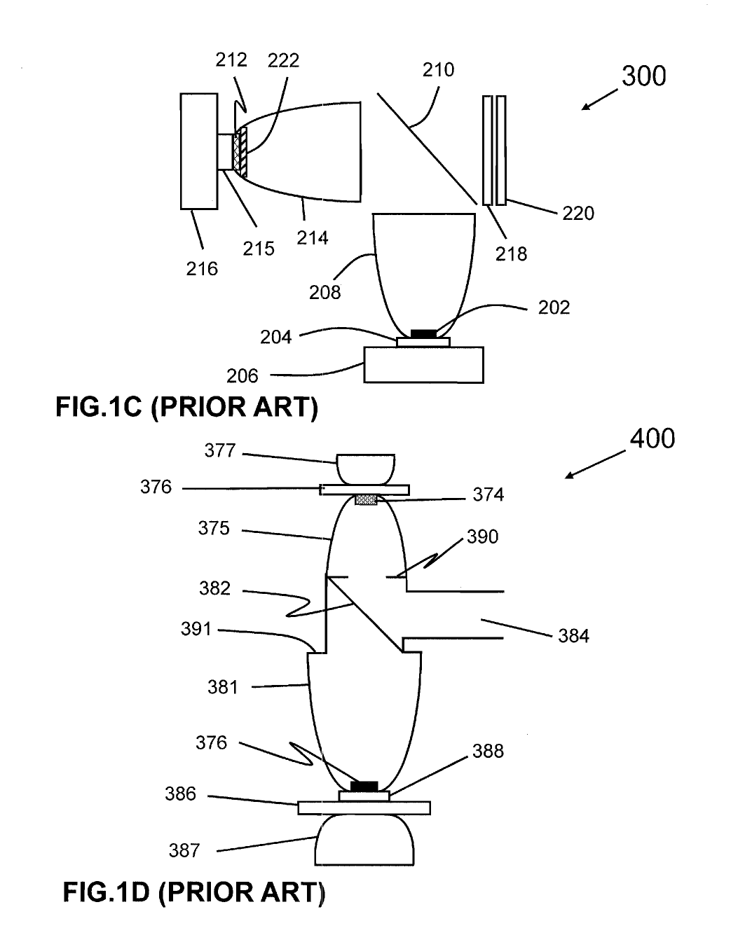

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

The word “exemplary” is used throughout this disclosure to mean “serving as an example, instance, or illustration.” Anything described herein as “exemplary” is not necessarily to be construed as preferred or advantageous over other approaches or features.

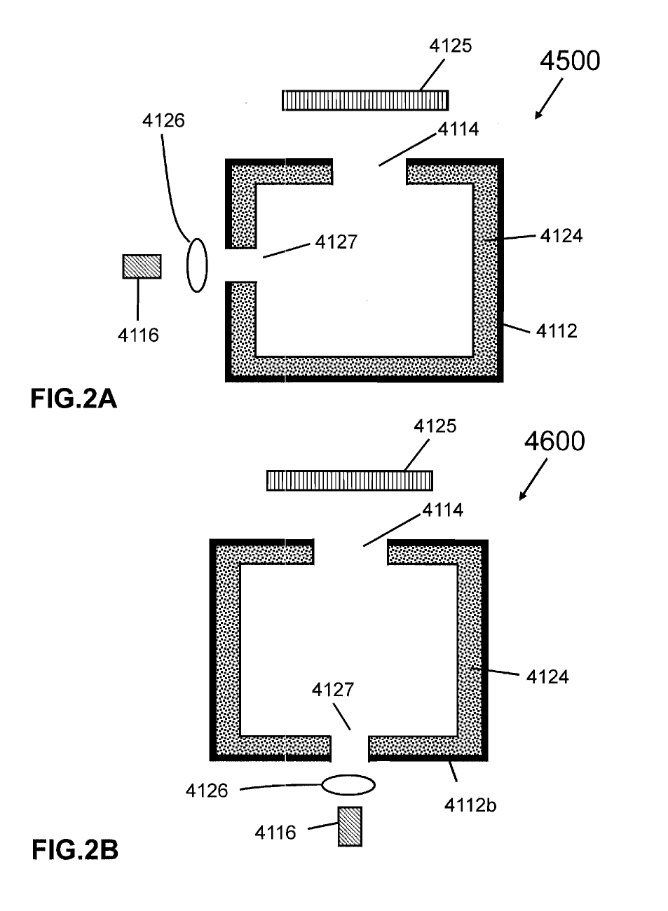

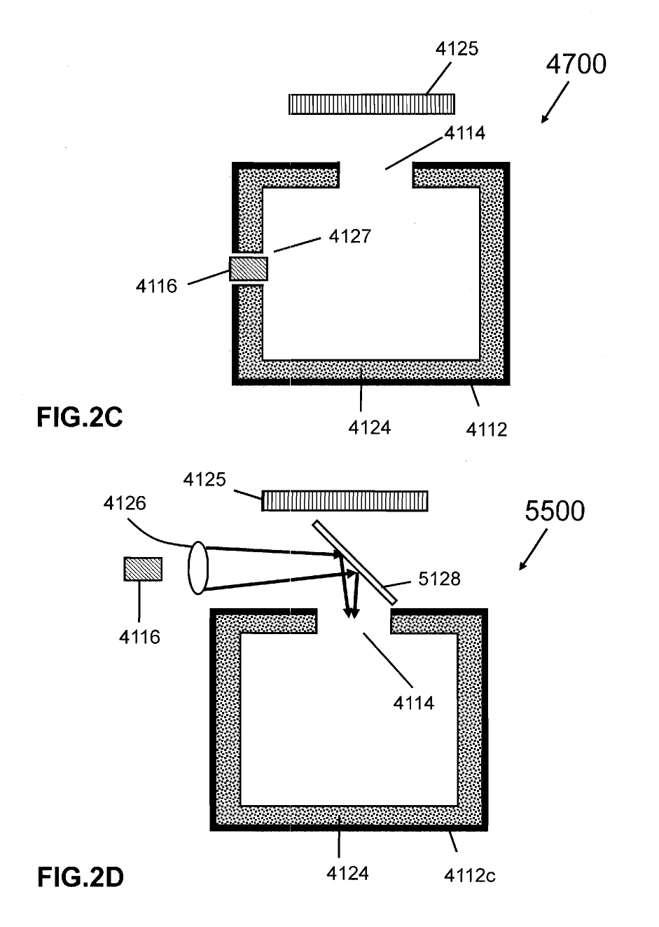

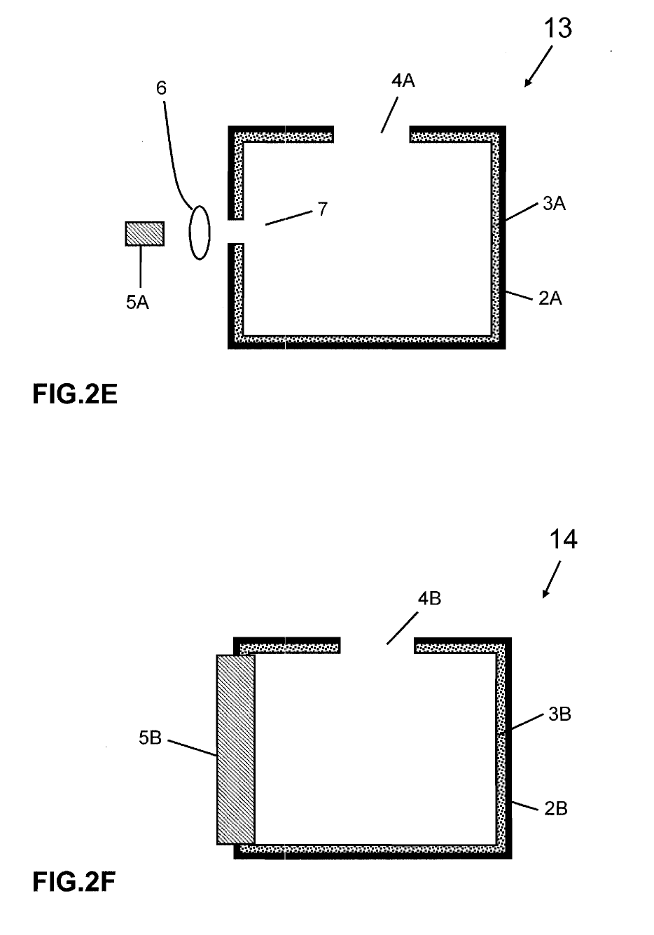

Light sources and illumination assemblies that utilize wavelength conversion materials such as phosphors and violet lasers are shown in FIGS. 2-5. Violet laser diodes are utilized in this disclosure due to the significant advantage they have over UV and blue laser diodes (in a wavelength range of 200-490 nm) in terms of their wall plug efficiency, commercial availability in high volumes, and/or low cost. Violet laser diodes in this patent refer to the laser diodes that emit light in the wavelength range of 405 nm±45 nm, more preferably in the wavelength range of 405 nm±25 nm, and most preferably in the wavelength range of 405 nm±10 nm. The maximum wall plug efficiency of laser diodes within a wavelength range of 200-490 nm is obtained at an approximate peak wavelength of 405 nm±45 nm. As the peak wavelength of these laser diodes shifts from 405 nm±45 nm toward the blue range or the UV range, their wall plug efficiency decreases. Furthermore, violet lasers have a huge recycling efficiency advantage over LEDs when utilized as an excitation light source for illumination systems of this disclosure as well as for illumination systems described in the prior art such as the ones discussed in U.S. Pat. Nos. 7,040,774 and 7,497,581. This recycling efficiency advantage is due to the fact that LEDs have limited reflectivity (typically 60%) and absorb a significant part of the light that impinges on their surface during the light recycling process that occurs within the recycling envelope. As the size of the output aperture of the recycling envelope is reduced to increase the brightness of the emitted light, the light losses due to absorption by the LED increase significantly. The typical losses in LED-based recycling envelope are more than 50%. When lasers are used as an excitation light source, the coupling of the laser light into the recycling envelope is done through a very small input aperture (via a focusing lens) or through a single input-output aperture and, thus, leading to very small optical losses (typically less than 5%) as some of the recycled light exits the system through the input aperture. When the violet laser diode is coupled to the recycling envelope through the output aperture (i.e., single aperture is used for inputting and outputting light as shown in FIG. 2D), these losses are eliminated. This advantage of lasers over LEDs is illustrated in the example given below in connection with FIGS. 2E-2F. In addition, the transverse multimode violet laser diodes have comparable wall plug efficiency when compared to that of violet and UV LEDs.

The wavelength conversion material of this disclosure absorbs light of a first wavelength range and emits light of a second wavelength range (i.e., converted light). The wavelength range of a converted light is different from that of the absorbed light, which is typically referred to as source, excitation, or pump light.

FIG. 2A shows a cross-sectional view of an exemplary illumination assembly 4500. Illumination system 4500 is comprised of a violet laser 4116, a wavelength conversion layer 4124 (e.g., phosphor), a light-recycling envelope 4112 made from a reflective material (or having a reflective coating applied to its internal surfaces), an optional lens (or a group of lenses) 4126, an optional optical element 4125 (e.g., reflective polarizer, micro-guide array, prism array, interference filter, or dichroic mirror) and a light output aperture 4114. The input aperture or opening 4127 can be located anywhere on the surface of the envelope 4112. It is possible to have one or more input apertures with one or more violet lasers in optical communication with each input aperture. It is also possible to have a combination of one or more violet lasers and non-violet lasers in optical communication with the envelope 4112 through one or more input apertures 4127. Illumination assembly 4500 may have one or more output apertures 4114. The optional lens 4126 can be replaced with an optional light guide or fiber to transfer the light emitted from the violet laser 4116 to the light-recycling envelope 4112 through an opening 4127 in the envelope 4112. Part of the source light gets absorbed by wavelength conversion layer 4124 and emitted at a second wavelength band. Recycling of the source light within the envelope 4112 helps convert more of it into the second wavelength band. Small portions of the source light and converted light exit the envelope 4112 through the opening 4127. Some of the light exiting through the output aperture 4114 gets transmitted and the remainder gets reflected back toward the envelope 4112 by optical element 4125. This process continues until all the light within the envelope 4112 is either transmitted through optical element 4125, absorbed or lost. Illumination system 4500 delivers light with enhanced brightness when compared to the total brightness of the source and converted light beams.

FIG. 2B shows a cross-sectional view of another exemplary illumination assembly 4600. Illumination assembly 4600 is the same as illumination assembly 4500 except for having a light envelope 4112b with an input opening 4127 and output opening or aperture 4114 aligned along one axis.

FIG. 2C shows a cross-sectional view of another exemplary illumination assembly 4700. Illumination assembly 4700 is the same as illumination assembly 4500 except for having the violet laser attached directly to the input opening 4127.

FIG. 2D shows a cross-sectional view of a further exemplary illumination assembly 5500. Illumination system 5500 is comprised of a violet laser 4116, a wavelength conversion layer 4124 (e.g., phosphor), a light-recycling envelope 4112c made from a reflective material (or having a reflective coating applied to its internal surfaces), an optional lens (or a group of lenses) 4126, a dichroic mirror 5128 that reflects the light emitted from the violet laser 4116 and transmits light at the converted wavelength, an optional optical element 4125 (e.g., reflective polarizer, micro-guide array, prism array, interference filter, or dichroic minor) and a light aperture 4114. Optical element 4125 can be placed in close proximity to the light aperture 4114 or between the dichroic minor 5128 and the light aperture 4114. Illumination system 5500 does not have a dedicated opening in the light-recycling envelope 4112c for inputting light received from the violet laser into the light-recycling envelope 4112c. A single opening or aperture 4114 is used in illumination assembly 5500 for inputting light from the light source and outputting converted light from the light-recycling envelope 4112c. The optional lens 4126 can be replaced with an optional light guide or fiber to transfer the light emitted from the violet laser 4116 to the dichroic minor 5128, which in turn reflects this light through an opening 4114 to the envelope 4112c. Alternatively, dichroic minor 5128 can be eliminated and source light emitted from the violet laser 4116 can be directly coupled to the light-recycling envelope 4112c through an opening 4114 in the envelope 4112c. The coupling can be done with or without a lens, fiber, light guide, or a combination of one or more of these. For example, a collimated laser beam can be inputted into opening 4114 and directed toward a diffuser placed within the recycling envelope 4112c or made as an integral part of the envelope's 4112c internal surface. The diffuser allows a more uniform distribution of the laser light within the recycling envelope 4112c, thus, avoiding heat spots and leading to more uniform heat distribution within the wavelength conversion material 4124. This means that the laser light impinges on the wavelength conversion material 4124 after exiting the diffuser and spreading within the recycling envelope 4112c, otherwise, a heat spot will be generated.

In other configurations, more than one violet lasers or a combination of one or more violet lasers with one or more lasers emitting at wavelengths other than the violet wavelength are used with illumination assembly 5500.

Illumination assembly 5500 may utilize a light-recycling envelope 4112c that has one or more output apertures 4114 with one or more violet lasers attached to each output aperture 4114. Illumination assembly 5500 may have a combination of violet and non-violet lasers.

Illumination assembly 5500 is more efficient than illumination assembly 4500 since it eliminates the optical losses that are associated with the dedicated input aperture 4127 of illumination assembly 4500. In addition, the manufacturing process of illumination assembly 5500 is highly simplified when compared to that of illumination assembly 4500. This is due to the large size of output aperture 4114 when compared to the dedicated input aperture 4127, which allows easier alignment between the laser 4116 and the aperture that receives the laser light. Increasing the size of the dedicated input aperture 4127 simplifies the alignment step in the manufacturing process of illumination assembly 4500 but it leads to increased optical losses.

The light-recycling envelope 4112, 4112b, 4112c of illumination assemblies 4500, 4600, 4700 and 5500 can be made of an optically transmissive material (with a reflective coating applied to its internal or external surfaces) or an optically opaque material (with a reflective coating applied to its internal surfaces).

In certain configurations, illumination assemblies 4500, 4600, 4700 and 5500 may have a low-refractive index layer (e.g., nano-porous SiO₂) located between the wavelength conversion layer 4124 and the reflective surface of the light-recycling envelope 4112, 4112b, 4112c (or the reflective coating applied to the surface of the light-recycling envelope 4112, 4112b, 4112c).

FIGS. 2E and 2F show cross sectional views of laser and LED based illumination assemblies 13 and 14, respectively. These two assemblies 13 and 14 are discussed here to illustrate the advantage that lasers have over LEDs as an excitation light source for illumination assemblies 4500, 4600, 4700, and 5500 in terms of optical efficiency. This advantage also applies to all illumination assemblies and systems of this disclosure. The light recycling envelopes 2A and 2B are cubes with inside dimensions of 2 mm×2 mm×2 mm. The cubes 2A and 2B have phosphor powder 3A and 3B covering their internal reflective surfaces except for the input aperture 3 that receives the focused light from the laser 5A, output aperture 4A and 4B that transmits the light out of the recycling cubes 2A and 2B, and the sidewall area of cube 2B where LED 5B is placed. The laser 5A is coupled to the cube 2A through a 0.05 mm diameter aperture 7 in one of the sidewalls of the cube 2A via a focusing lens 6. The LED 5B replaces a 2 mm×2 mm sidewall of the cube 2B and is attached to the cube 2B as shown in FIG. 2F. Table 1 below shows the calculated optical efficiencies (power of light exiting output aperture 4A and 4B divided by the power received from the light source 5A and 5B) of the LED and laser based illumination assemblies 13 and 14. The optical efficiencies were calculated for a square output aperture 4A and 4B with 0.32 mm×0.32 mm and 0.63 mm×0.63 mm sizes. The ratio R of the output aperture's area Aₒₐ divided by the cross section area Aᵣₑ of the recycling envelope 2A and 2B is shown in Table 1. The cross section area Aᵣₑ is 2 mm×2 mm, which is equal to 4 mm². The input and output light powers are in Watts and the optical efficiency is a dimensionless value. These results were obtained using TracePro simulation tool from Lambda Research. The LED reflectivity is assumed to be 60%, which is close to the reflectivity value of the commercially available LEDs. The reflectivity of the internal surfaces of both recycling cubes 2A and 2B is assumed to be diffusive. The optical efficiency was calculated for two reflectivity values of 99% and 100% as shown in Table 1. Both of the reflectivity values reflect an effective reflectivity that takes into consideration the effect of the phosphor powder coating on the reflectivity of the material or coating below the phosphor coating. However, the optical efficiency calculations do not take into consideration losses due to stokes shift, the conversion efficiency of the light conversion material enclosed within the cube or its other optical properties (e.g., phosphor absorption) since the impact of these factors on the LED and laser based illumination assemblies 13 and 14 is comparable. Table 1 below shows an optical efficiency advantage of more than 3× (and can be >15×) for a laser based illumination assembly 13 over LED based illumination assembly 14. Therefore, lasers rather than LEDs are selected as an excitation light source for the illumination assemblies of this disclosure. More specifically violet laser diodes rather than blue or UV laser diodes are selected as the laser diode source due to their higher wall plug efficiency when compared to blue and UV laser diode lasers.

TABLE 1

| | Ratio | | | |
|---|---|---|---|---|
| Light | R = Aₒₐ/ | Area of Output | Reflectivity of | Optical |
| Source | (4 mm²) | Aperture (Aₒₐ) | the cube surface | Efficiency |
| LED | 2.6% | 0.32 mm × 0.32 mm | 100% | 5.6% |
| LED | 2.6% | 0.32 mm × 0.32 mm | 99% | 4.8% |
| Laser | 2.6% | 0.32 mm × 0.32 mm | 100% | 97.4% |
| Laser | 2.6% | 0.32 mm × 0.32 mm | 99% | 29.7% |
| LED | 10% | 0.63 mm × 0.63 mm | 100% | 18.7% |
| LED | 10% | 0.63 mm × 0.63 mm | 99% | 18.1% |
| Laser | 10% | 0.63 mm × 0.63 mm | 100% | 99.7% |
| Laser | 10% | 0.63 mm × 0.63 mm | 99% | 62.2% |

Table 1 also shows the impact of having a high reflectivity coating on the optical efficiency. For example, the optical efficiency for a laser based illumination system 13 with an output aperture 4A of 0.32 mm×0.32 mm drops from 97.4% to 29.7% as the reflectivity of the cube 2A drops from 100% to 99%. Therefore, using a low-refractive index layer (e.g., nano-porous SiO₂) between the wavelength conversion layer (e.g., phosphor) and the reflective surface of the light-recycling envelope is critical for maintaining a high overall reflectivity (e.g., >99.5%) within the light recycling envelope. Thus, leading to a high optical efficiency of illumination assemblies and systems of this disclosure and ensuring the superiority of laser based illumination assemblies and systems over LED based illumination assemblies and systems in terms of optical efficiency.

A dichroic minor (that transmits source light of LED 5B and reflects converted light generated within the recycling cube 2B) can be deposited directly on the surface of LED 5B or placed in close proximity to the surface of LED 5B. Such a dichroic mirror reduces losses due to light absorption by the LED 5B and, thus, enhances the efficiency of the recycling cube 2B. However, this efficiency enhancement is limited due to the limited reflectivity of the dichroic minor over a wide range of incident angles.

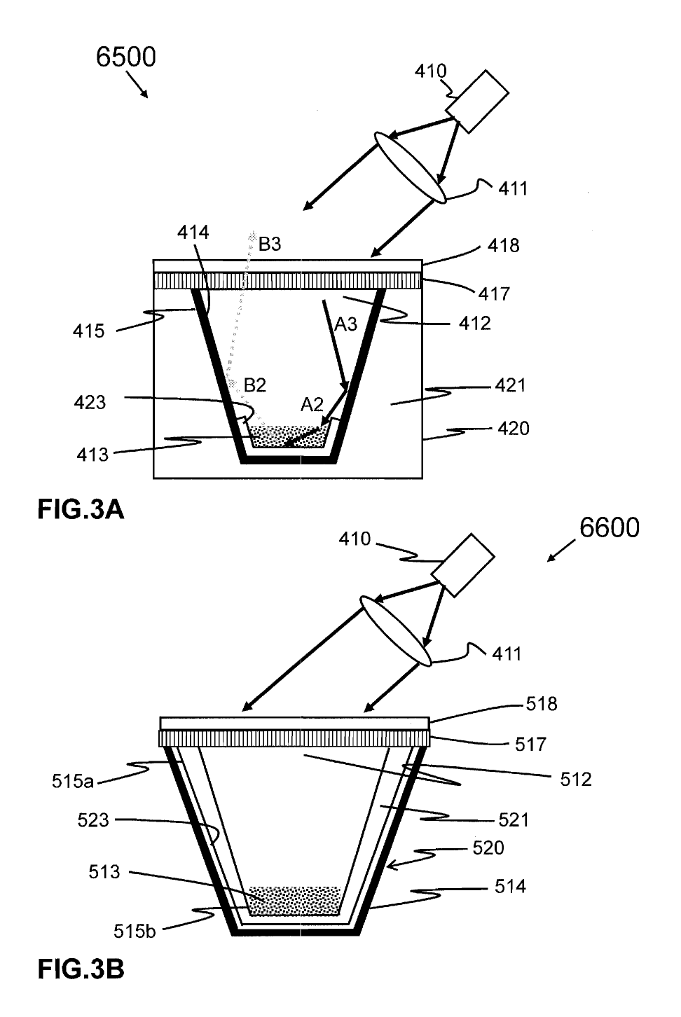

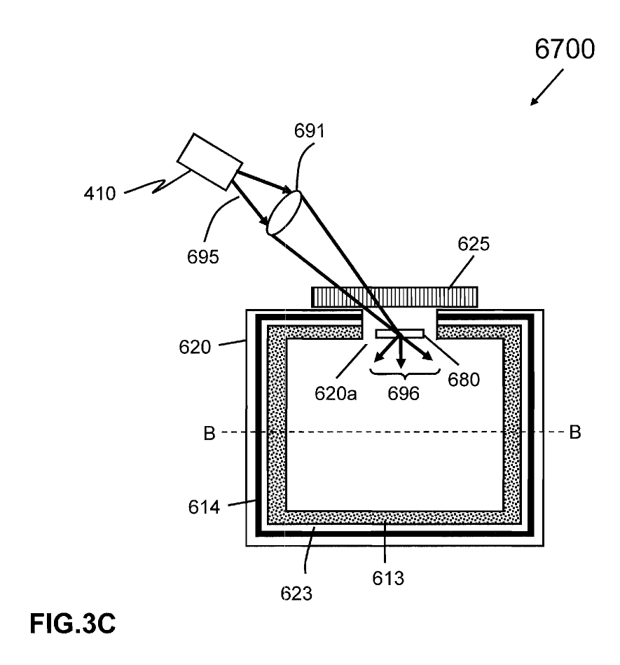

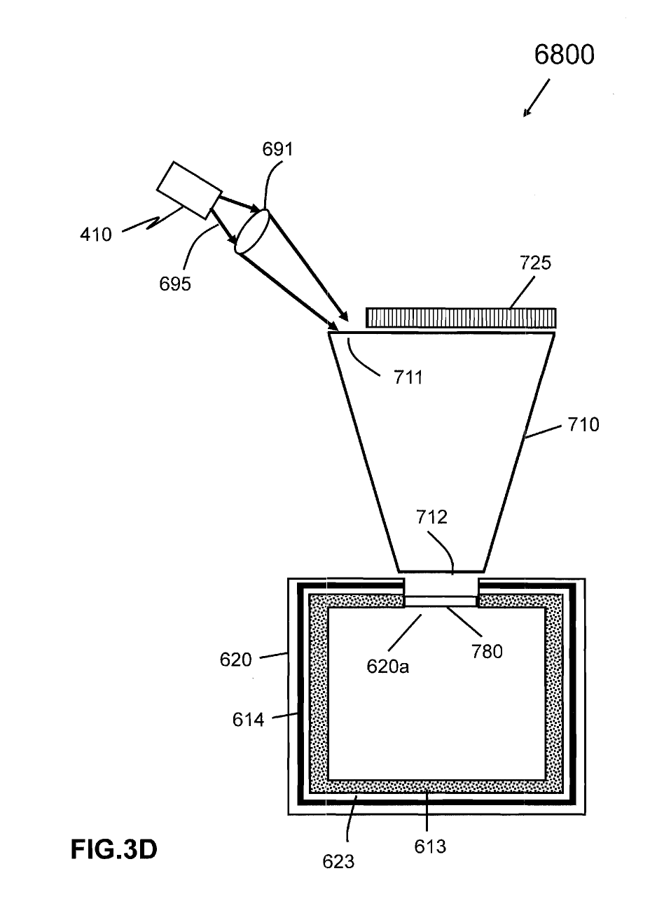

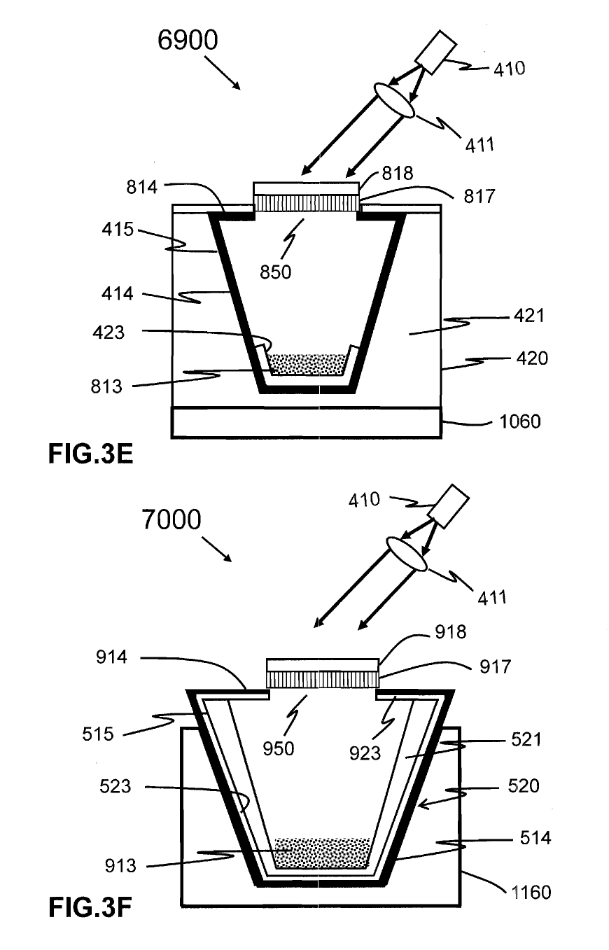

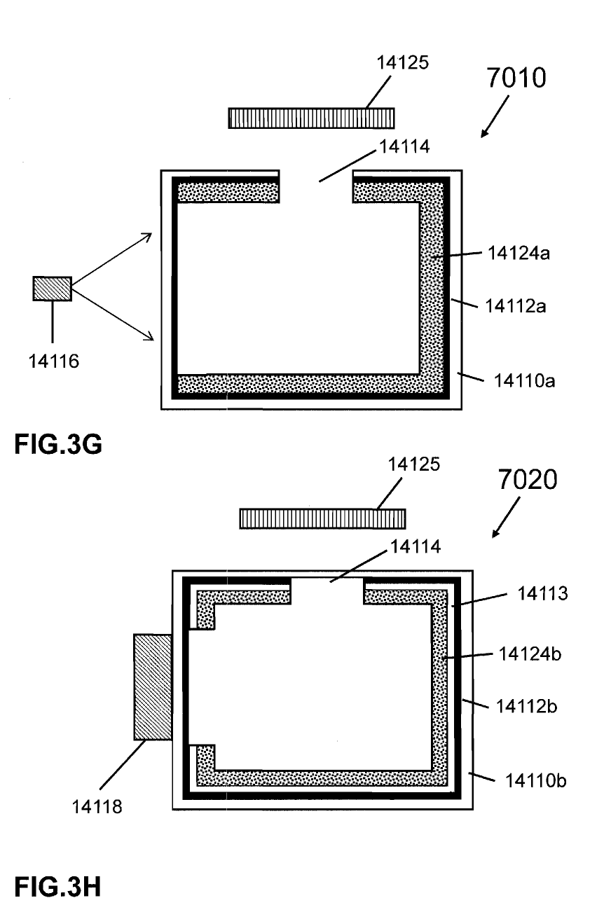

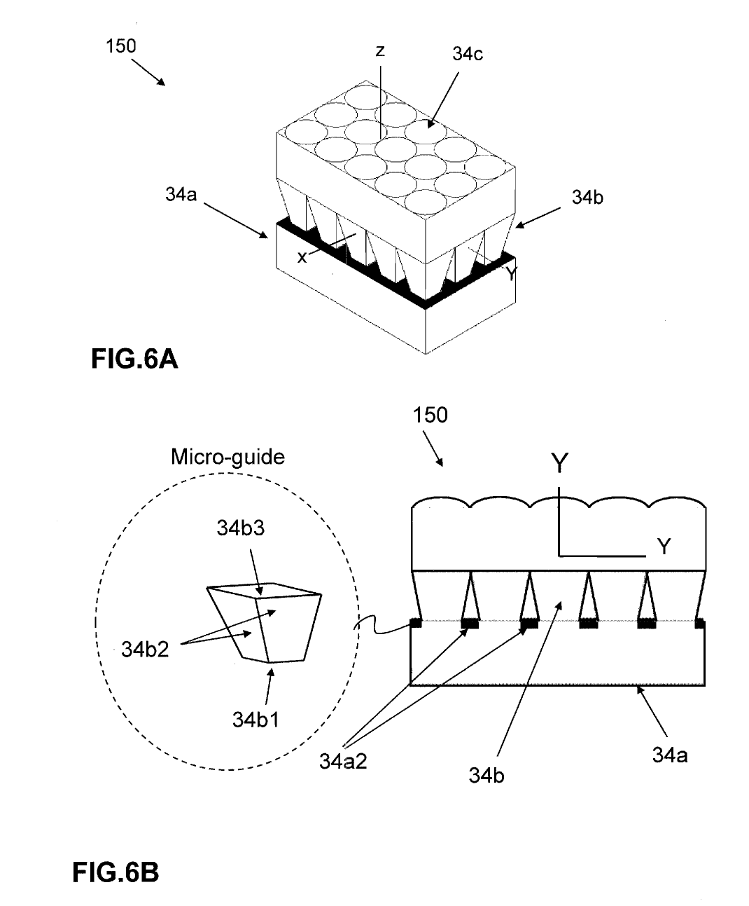

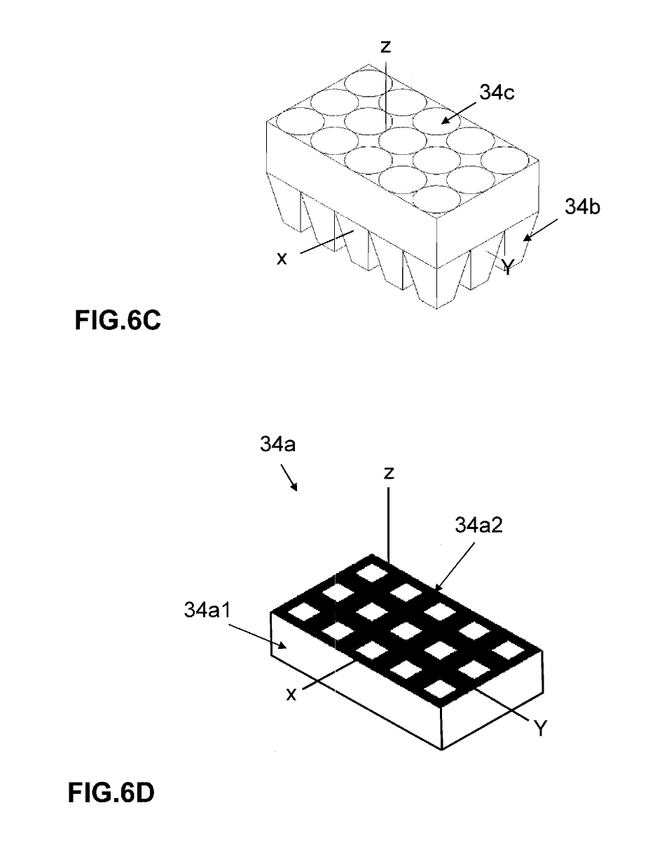

FIG. 3A shows a cross-sectional view of an exemplary illumination assembly 6500. Illumination assembly 6500 comprises a violet laser 410, hollow light envelope (or guide) 420 with an aperture 412, a wavelength conversion layer 413, an optional low-refractive index layer 423 located between the wavelength conversion layer 413 and the reflective coating 414, an optional lens 411, an optional optical element 417 located at or beyond the clear aperture 412 of the light envelope 420, and an optional collimating plate 418 located at the exit aperture of optical element 417. Alternatively, the collimating plate 418 can be located between the aperture 412 of the light envelope 420 and the input aperture of optical element 417. The hollow light envelope 420 can be made of an optically transmissive or opaque material 421 with a reflective coating 414 applied to its internal surfaces 415. Lens or a group of lenses 411 directs the light beam of source 410 toward the aperture 412. Lens 411 can be used to focus, partly collimate or fully collimate the light beam. Lens 411 can be removed and source 410 can be connected directly (or brought in close proximity) to the aperture 412. It is also possible to use a solid or hollow light guide or an optical fiber to couple light from the source 410 to the aperture 412. The low-refractive index layer 423 can extend beyond the wavelength conversion layer 413 to cover the interior surface of the reflective coating 414 partly or completely. The refractive index n of layer 423 should be lower than that of the wavelength conversion layer 413 and preferably below 1.2. Examples of such layer 423 include air (n=1) and nano-porous SiO₂ (n=1.1). Nano-porous SiO₂ is preferable since it conducts heat more efficiently than an air gap. Light guide can have straight sidewalls, tapered sidewalls, a combination of both, any other shape, or an arbitrary. The light guide is preferably made of a material having high thermal conductivity to help dissipate heat generated within the phosphor layer. However, this light guide can be made of metal, semiconductor (e.g., silicon and diamond), glass, organic material, inorganic material, translucent material, substrates coated with thermally conductive films such as diamond, molded plastic or molded metal (e.g., aluminum and metal alloys). Optical element 417 can be a reflective polarizer, dichroic minor, a dichroic cube, diffractive optical element, micro-refractive element, brightness enhancement film, hologram, a filter that blocks (absorbs and/or reflects) UV or near UV light, a photonic crystal, a diffuser, light interference filter, or a combination of two or more of these elements. A photonic crystal is a one-, two- or three-dimensional lattice of holes formed in a substrate, film, coating or semiconductor layer. The manufacturing of photonic crystals is described by Erchak et al. in U.S. Pat. No. 6,831,302 B2, which is incorporated herein by reference. The different structures and operation of collimating plate 418 are discussed below in connection with FIGS. 6-9. The reflective coating is preferably specular but can be diffusive. For example, a diffractive optical element that passes a light with limited cone angle and reflects high-angled light can be used to enhance the brightness of delivered light. Optical element 417 can be purchased from Oerlikon Optics USA Inc. located in Golden, Colo., Optical Coating Laboratory, Inc. located in Santa Rosa, Calif., and 3M located in St. Paul, Minn.

The light envelope 4112, 4112b, 4112c, 420 is a 3-dimensional surface that encloses an interior volume and has at least one aperture for inputting and outputting light. The 3-dimensional surface can have any desired shape such as a cubical, oblate spheroid, tunnel with tapered sidewalls, arbitrary, or irregular shape. The 3-dimensional surface (without considering external optical elements) may include partial recycling of light (source and/or converted light) and may not have recycling (i.e., all light exits through the aperture of the 3-dimensional surface). The size and shape of the aperture (i.e., opening) 4114, 412 can be circular, square, rectangular, oval, one or two dimensional array of openings, or any other shape. For example, aperture 4114, 412 can receive a line of light from a laser source, laser array, or micro-laser array in the violet wavelength range or a combination of at least one violet laser and at least one laser outside the violet wavelength range. It is also possible to have an array of apertures associated with an array of lenses corresponding to an array of violet and non-violet lasers. The area Aₒₐ of the output aperture 4114, 412 (and output apertures of illumination assemblies and systems described later in this disclosure) can range from tens of μm² to several mm² depending on the type of light source, source wavelength, the size of the light beam as well as shape and size of the light envelope 4112, 4112b, 4112c, 420. The output aperture's area Aₒₐ divided by the cross section area Aᵣₑ of the recycling envelope can be used as a measure R of the brightness enhancement of the light source or illumination assembly. For the micro-projector applications, the value of R=Aₒₐ/Aᵣₑ is preferably between 0.01 and 1.00 and more preferably between 0.02 and 0.10.

The length of light envelope 4112, 4112b, 4112c, 420 and light envelopes of illumination assemblies and systems of this disclosure range from a sub-millimeter to tens of millimeters depending on the size of its entrance and exit apertures, cone angle of light propagating within the light envelope 4112, 4112b, 4112c, 420 and degree of desired light uniformity. Examples of some suitable light envelopes (or guides) are described in related U.S. patent application Ser. Nos. 10/458,390, filed on Jun. 10, 2003, and 11/066,616, filed on Feb. 25, 2005, which are incorporated herein by reference.

The operation of illumination assembly 6500 is described as follows. Light emitted from violet laser source 410 is collimated (or focused) by lens 411 and transmitted into the light envelope 420 through optional optical element 417, optional collimating plate 418 and clear aperture 412. Some of the received light strikes the wavelength conversion layer 413. Part of the light impinging on the wavelength conversion layer 413 gets absorbed and converted into light with a new wavelength band (i.e., converted light) and the remainder gets diffused by the wavelength conversion layer 413 but does not get converted. Both the source light and converted light get collimated by the light envelope 420 and impinge on the entrance aperture of optical element 417 and collimating plate 418 at a reduced cone angle when compared to that of the diffused source light and converted light at the wavelength conversion layer 413. Optical element 417 reflects a substantial amount of the source light that impinges on it toward the wavelength conversion layer 413, thus, providing another chance for source light to be converted by the wavelength conversion layer 413. The low-refractive index layer 423 enhances the reflectivity of the reflective coating (or mirror) 414, which is located below the wavelength conversion layer 413, and establishes with the reflective coating 414 an omni-directional reflector with very low optical losses. The thickness of the low-refractive index layer 423 is approximately equal to λ/4n, where λ is the wavelength of light propagating in the low-refractive index layer 423 and n is the refractive index of the low-refractive index layer 423. In order to prevent the evanescent wave field from reaching the mirror below the low-refractive index layer 423, the thickness of low-refractive index layer 423 is preferably made larger than the λ/4n value. For example, this thickness is preferably made 1 μm or larger for visible light cases. The low-refractive index layer 423 can be electrically insulating or conducting and can be, for example, made of air or nano-porous SiO₂, which has a low refractive index n of 1.10. The mirror 414 located below the low-refractive index layer 423 can be made of a metal reflector (e.g., silver or Al), a multilayer stack of high-index low-index dielectric materials (e.g., TiO₂/SiO₂), or a multilayer stack of high-index low-index dielectric materials followed by a metal reflector. Discussions of omni-directional reflectors are presented by J.-Q. Xi et al. in the “Internal high-reflectivity omni-directional reflectors”, Applied Physics Letters 87, 2005, pp. 031111-031114, Fred E. Schubert in U.S. Pat. No. 6,784,462, and Jae-hee Cho in U.S. patent application Ser. No. 11/271,970. Each of these three documents is incorporated herein by reference.

Since efficiency of optical element 417 (e.g., a dichroic minor) in reflecting light impinging on it is higher for light with a limited cone angle at a designed angel of incidence, utilizing a tapered light envelope 420 leads to the collimation of the source light, which gets diffused by the wavelength conversion layer 413, and allows better conversion efficiency. On the other hand, recycling of light within a tapered light envelope 420 can lead to an increase in the cone angle of light when compared to a tapered light envelope with no recycling. In order to maximize the optical efficiency, one should consider the degree of light recycling (e.g., reflectivity of dichroic minor) and the amount of sidewall tapering of a light envelope when designing such an illumination system. To minimize reflections (i.e., losses) from the dichroic minor 417, one can input the laser beam received from source 410 at a selected angle of incidence with respect to the dichroic mirror surface, which depends on the design of dichroic minor 417. Alternatively, a clear opening in the optical element 417 (or a dichroic mirror) can be made to allow (collimated or focused) light received from violet laser source 410 into light envelope 420 without significant losses and regardless of its angle of incidence with respect to the dichroic mirror surface.

The different structures and operation of collimating plate 418 are discussed below in connection with FIG. 6-9.

FIG. 3B shows cross-sectional view of another exemplary illumination assembly 6600. Illumination assembly 6600 utilizes a hollow light envelope (or guide) 520 made from an optically transmissive material 521 and a reflective coating 514 applied to the external surface of light envelope 520. The term optically transmissive means that light (in the relevant wavelength range) passes through the material, composition or structure with little or no absorption. Illumination assembly 6600 consists of a violet laser 410, hollow light envelope 520, a wavelength conversion layer 513, an optional low-refractive index layer 523 located between the external surface 515a of the hollow light guide 520 and the reflective coating 514, optional lens 411, an optional optical element 517 located at or beyond the aperture 512 of the light envelope 520, and an optional collimating plate 518 located at the exit aperture of optical element 517. Alternatively, the collimating plate 518 can be located between the aperture 512 of the light envelope 520 and the input aperture of optical element 517. Light enters the hollow light envelope 520 through aperture 512, optional optical element 517 and optional collimating plate 518. The functions of reflective coating 514, wavelength conversion layer 513, low-refractive index layer 523, violet laser 410, lens 411, optical element 517 and collimating plate 518 are similar to these described in connection with FIG. 3A. The operation of illumination assembly 6600 is similar to that of illumination assembly 6500.

Illumination assembly 6600 has the advantage of allowing the application of the reflective optical coating 514 and low-refractive index layer 523 after performing the curing and/or annealing step of the wavelength conversion layer 513. Since exposing the reflective optical coating 514 and low-refractive index layer 523 to high temperatures may degrade their quality, a design that allows the application of such coatings 514 and 523 to the light envelope 520 after completing the high-temperature curing/annealing step is highly desirable. In some cases where high temperature treatment does not degrade the low-refractive index layer 523, this layer 523 can be sandwiched between the internal surface 515b of the light guide 520 and the wavelength conversion layer 513.

FIG. 3C shows a cross-sectional view of another exemplary illumination assembly 6700. Illumination assembly 6700 consists of a violet laser 410, hollow light envelope (or guide) 620 with an aperture 620a, a wavelength conversion layer 613, an optional low-refractive index layer 623 located between the wavelength conversion layer 613 and the reflective coating 614, an optional lens 691, an optional optical element 625 located at or beyond the clear aperture 620a of the light envelope 620, and an optional diffusing element 680 located at the aperture 620a. The area of output aperture 620a is smaller than the cross sectional area (along line B) of envelope 620. Lens 691 is used to direct (or focus) light 695 from source 411 into aperture 620a of envelope 620. Other means such as optical fibers, dichroic minors, prisms, or light guides can be used to direct light from source 411 into aperture 620a. Diffusing element 680 is used to diffuse the received light so that output light 696 is distributed more uniformly within the light envelope 620. This helps in distributing the generated heat within the light conversion material 613 more uniformly, thus, enhancing the performance of the illumination system 6700. Optical element 625 is preferably a coating that reflects non-converted light (i.e., light received from source 411 that was not absorbed or converted within light envelope 620) back to light envelope 620 and allows the converted light to pass out of the envelope 620. Alternatively, optical element 625 can be a reflective polarizer, dichroic mirror, a dichroic cube, diffractive optical element, micro-refractive element, brightness enhancement film, interference filter, hologram, a filter that blocks (absorbs and/or reflects) UV or near UV light, a photonic crystal, a diffuser, micro-guide array, or a combination of two or more of these elements.

FIG. 3D shows a cross-sectional view of an exemplary illumination assembly 6800. Illumination assembly 6800 consists of a violet laser 410, hollow light envelope (or guide) 620 with an aperture 620a, a wavelength conversion layer 613, an optional low-refractive index layer 623 located between the wavelength conversion layer 613 and the reflective coating 614, an optional lens 691, an optional diffusing element 780, collimating optical element 710, and an optional optical element 725 located at or beyond the exit aperture of collimating optical element 710. All components of illumination assembly 6800 have been described in connection with illumination assembly 6700 except for collimating optical element 710, diffusing element 780 and optical element 725. Collimating optical element 710 can be a tapered light guide (hollow with reflective sidewalls or uncoated solid light pipe), a lens (or group of lenses), micro-guide array, or any other collimating optics. Diffusing element 780 is preferably located at the aperture 720a of the light envelope 720 and has the function of diffusing the received light so that more uniform distribution of source light 695 within light envelope is achieved. Optical element 725 is preferably a coating that reflects non-converted light (i.e., light received from laser source 411 that was not absorbed or converted within light envelope 620) back to light envelope 620 and allows the converted light to pass out of the envelope 620. Alternatively, optical element 725 can be a reflective polarizer, dichroic mirror, a dichroic cube, diffractive optical element, micro-refractive element, brightness enhancement film, interference filter, hologram, a filter that blocks (absorbs and/or reflects) UV or near UV light, a photonic crystal, a diffuser, or a combination of two or more of these elements. As shown FIG. 3D, lens 691 directs source light 695 through a clear area 711 in optical element 725 into collimating optical element 710, which in turn channels source light into diffusing element 780 and envelope 620. Part of source light gets absorbed by wavelength layer 613 and converted into light within another wavelength band. The remainder of source light gets reflected toward other parts of the envelope 620 including its aperture 620a. A substantial amount of source light that exits envelope 620 through its aperture 620a will be reflected back to envelope 620 by optical element 725. Due to the use of the light envelope 620 and optical element 725, source light will have many chances to convert into light within a desired wavelength, thus, enhancing the optical efficiency of the system.

The wavelength conversion layer 4124, 613 may be applied to part of the internal surface of the light envelope 4112, 4112b, 4112c, 620.

The reflective coating 614 and/or the optional low-refractive index layer 623 may be applied to the outside surface of the light envelope 620. This configuration assumes that the light envelope 620 is made of optically transmissive material for light within the wavelength bands of the source and converted light.

Source light may be inputted into collimating optical element 710 through its sidewalls. This configuration assumes the sidewalls of the collimating optical element 710 are not coated with a reflective coating within the source wavelength range. The source light can be inputted through a small area within the surface of the sidewalls at a certain angle and location so that a substantial amount of inputted light exits collimating optical element 710 through its entrance aperture 712 into aperture 620a.

FIGS. 3E and 3F show cross-sectional views of exemplary illumination assemblies 6900 and 7000. Illumination assemblies 6900 and 7000 utilize hollow light envelopes (or guides) 420 and 520 with tapered sidewalls and smaller output apertures 850 and 950 (when compared to apertures 412 and 512 of FIG. 3A-3B). The smaller output apertures 850 and 950 permit enhanced light coupling efficiency in case of etendue limited systems. The reflective coatings 414, 514, 814 and 914 may reflect part or all of the wavelength bands available within the light guides 420 and 520. A low-refractive index layer 923 can be placed at the bottom side of the reflective coating 914 as shown in FIG. 3E to enhance its reflectivity and reduce losses. The wavelength conversion layers 813 and 913 can have any selected pattern. The wavelength conversion layers 813 and 913 can coat the whole (or part of) internal surface of hollow light guides 420 and 520 or fill the whole (or part of) interior volume of hollow light guides 420 and 520. Illumination assemblies 6900 and 7000 also include optional optical element 817 and 917 located at or beyond the output apertures 850 and 950 of the light guides 420 and 520, as well as optional collimating plates 818 and 918 located at the exit apertures of optical elements 817 and 917. As shown in FIGS. 3E-3F, optional heat sinks 1060 and 1160 are utilized to dissipate heat generated in the wavelength conversion layers 413 and 513. Shapes, sizes and materials of such heat sinks 1060 and 1160 are not limited to these shown in FIGS. 3E-3F. Other parts 410, 411, 420, 421, 423, 414, 415, 520, 521, 523, 514, 515 of illumination assemblies 6900 and 7000 have the same function as these of illumination assemblies 6500 and 6600 shown in FIGS. 3A and 3B.

Illumination assemblies 6800, 6900 and 7000 have the advantage of providing light with higher brightness through smaller output apertures 620a, 850 and 950 and operate in similar ways as described in illumination assemblies 6500 and 6600 except for the extra light recycling done by the reflective coatings 614, 814 and 914. Since wavelength conversion materials (e.g., phosphors) have very low absorption of the converted or generated light, the recycling efficiency can be very high as long as other losses in the illumination assembly are minimized. Illumination assemblies that can deliver light with enhanced brightness or utilize lasers are discussed in U.S. Pat. No. 7,070,300 and U.S. Pat. No. 7,234,820 to Harbers et al., U.S. Pat. Nos. 7,040,774 and 7,497,581 to Beeson et al. and U.S. patent application Ser. No. 11/702,598 (U.S. Published Patent Application 2007/0189352) to Nagahama et al., which are all incorporated herein by reference.

Each of illumination assemblies 6800, 6900 and 7000 may have two or more output apertures 620a, 850 and 950 (i.e., an array of output apertures per a single light envelope).

The illumination assemblies 6500, 6600, 6700 and 6800 may be provided with heat sinks similar to these of FIGS. 3E and 3F.

The portion of the interior volume of the hollow light guide 420 and 520 that has no wavelength conversion layer can be filled (partly or completely) with a transparent material such as gas, liquid, paste, glass, and plastic.

The wavelength conversion layer 4124, 413, 513, 613, 813 and 913 can be made by mixing a phosphor powder and a glass powder and molding the obtained mixed powder utilizing, for example, a hot press molding. Alternatively, a binding medium (e.g., epoxy or silicone) containing phosphor particles is molded to have a desired shape (e.g., a sheet that can divided into smaller sizes).

The wavelength conversion layer 4124, 413, 513, 813 and 913 can be a quantum dot material (solid, powder, or particles), solid phosphor, a luminescent dopant material or a binding medium containing a quantum dot material and/or a luminescent dopant material. The wavelength conversion material 4124, 413, 513, 613, 813 and 913 can be attached to the light guide 4112, 4112b, 4112c, 420, 520 and 620 using low melting glass, a resin, fusion or high temperature fusion. It is also possible to apply the phosphor powder of each color by screen printing, injection printing, or dispenser printing using paste which is mixed in preparation with a binder solution containing, for example, terpineol, n-butyl-alcohol, ethylene-glycol, and water. Examples of phosphor materials that generate green light include thiogallate (TG), SrSiON:Eu, and SrBaSiO:Eu. Phosphor materials that generate amber light include BaSrSiN:Eu. Phosphor materials that generate red light include CaS:Eu, (Sr_{0.5},Ca_{0.5})S:Eu, SrS:Eu, and SrSiN:Eu and YAG is a phosphor material that generates white light. In addition, other wavelength conversion materials such as dyes can be used. The wavelength conversion layer 4124, 413, 513, 613, 813 and 913 may fully fill or partly fill the interior volume of the hollow light guide 4112, 4112b, 4112c, 420, 520 and 620. Depending on the application, the thickness, length and width of the wavelength conversion layer 4124, 413, 513, 613, 813 and 913 range from sub-millimeters to tens of millimeters. However, it is preferable for miniature projector applications to have a wavelength conversion layer with a diameter of 0.5-5 mm and a thickness of 0.01-1.0 mm.

The wavelength conversion layer 4124, 413, 513, 613, 813 and 913 may consist of mixtures and/or patterns of different types or amounts of phosphor. For example, the wavelength conversion layer 4124, 413, 513, 613, 813 and 913 may include a blend of red, green, and blue phosphors that are excited by the violet laser source 410 that emits a lower wavelength range. The combined red, green and blue light emitted from the phosphor blend forms a white light. Alternatively, the wavelength conversion layer 4124, 413, 513, 613, 813 and 913 may include a blend of red and green phosphors that are excited by violet and blue laser sources 410. In this case, the optical element 417, 517, 817 and 917 is partially transparent to blue light, thus, leading to the delivery of a white light (i.e., a combination of red, green and blue colors). In a second example, a blend of yellow and blue phosphors that are excited by a blue, near UV, or UV laser can be used to deliver white light for a certain application (e.g., automobile headlight).

The wavelength conversion layer 4124, 413, 513, 613, 813 and 913 may consist of one or more layers of different types of phosphors (e.g., red, green and blue phosphors) stacked on top of each other or placed next to each other.

A diffusing agent may be added to the wavelength conversion material 4124, 413, 513, 613, 813 and 913. Alternatively, a transmissive diffuser (rough surface, micro-lens array, micro/nano structured material, a lens, tapered cone made of glass or other type of transparent material) can be provided in the path of the light beam received from the light source in order to increase its cone angle.

Additionally/alternatively, the whole wavelength conversion layer 4124, 413, 513, 613, 813 and 913 is patterned into one dimensional or two dimensional structures (e.g., prisms, pyramids, squares, rectangles). Such patterns can be large (sub-millimeters to several millimeters in size) or small (few to tens of microns in size). Rather than filling the whole interior volume, the wavelength conversion layer 4124, 413, 513, 613, 813 and 913 can cover the interior or exterior surface of a light guide 4112, 420, 520 and 620 partly or completely.

The surface of the wavelength conversion layer 4124, 413, 513, 613, 813 and 913 may be patterned into one dimensional or two dimensional structures (e.g., prisms, pyramids, squares, rectangles). Such patterns can be large (sub-millimeters to several millimeters in size) or small (few to tens of microns in size). The patterning of the surface or whole depth of the wavelength conversion layer 4124, 413, 513, 613, 813 and 913 provides a more efficient absorption of excitation light and collection of converted light.

The light source 410 consists of more than one light source (e.g., violet lasers, UV lasers, blue lasers, LEDs, or combination of two or more of these light sources) coupled to the light envelope 4112, 4112b, 4112c, 420, 520 and 620 through its aperture 4127, 4114, 412, 512, 620a, 850 and 950 (or one or more of its array of apertures). The multiple light beams from multiple sources can be combined through the use of dichroic minors that combine the multiple light beams having same or different wavebands (e.g., UV, violet and Blue) from multiple sources (e.g., lasers) into a single light beam. Alternatively, the light beams can be inputted directly (or through a lens, group of lenses, or any coupling optics) into the aperture where each light beam has its own tilt angle with respect to the optical axis of the illumination assembly. For example, it is possible to use a focusing lens to focus light from two or more lasers (array of lasers or micro-lasers) having same or different wavelengths into at least one aperture 4127, 4114, 412, 512, 620a, 850 and 950. In case of having multiple apertures, each aperture may receive light from at least one laser (or micro-laser) in the array. Examples of the laser source 410 include a semiconductor light emitting device having a peak emission wavelength ranging from 360 nm to 500 nm and a laser diode device having a peak emission wavelength in the vicinity of 405 nm or in the vicinity of 445 nm. The laser source 410 can be GaN-based laser diode.

FIGS. 3G and 3H show cross-sectional view of exemplary illumination assemblies 7010 and 7020. Illumination assemblies 7010 and 7020 have a dichroic coating 14112a and 14112b covering the internal surface of a hollow recycling envelope 14110a and 14110b except the output aperture 14114. This dichroic coating 14112a and 14112b transmits the source light and reflects the converted light back into the envelope 14110a and 14110b. Utilizing recycling envelopes 14110a and 14110b made of optically transmissive material with dichroic coatings 14112a and 14112b allows the introduction of the source light 14116 and 14118 into the recycling envelope 14110a and 14110b through its surface without the need for a dedicated input aperture. The wavelength conversion material 14124a and 14124b partly covers the internal surface of the envelope 14110a and 14110b. As shown in FIGS. 3G and 3H, it is preferable not to cover the surface area that receives the light from the source in order to reduce the optical losses due to back reflection by the wavelength conversion layer. Illumination assemblies 7010 and 7020 have an optional optical element 14125 located at or beyond the output aperture 14114. Illumination assembly 7020 has an optional low-refractive index layer 14113 located between the wavelength conversion layer 14124b and the reflective coating 14112b. Since envelope 14110a and 14110b are optically transmissive, the dichroic coating 14112a and 14112b and low-refractive index layer 14113 can be applied to the external surface of envelope 14110a and 14110b. The optical efficiencies of illumination assemblies 7010 and 7020 are limited due to the limited reflectivity of the dichroic coatings 14112a and 14112b over a wide range of angles of incidence and light wavelengths, which are typically the characteristics of light that exist in a recycling envelope 14110a and 14110b. Therefore, illumination systems that utilize mirrors that are highly reflective (e.g., silver mirrors and silver mirrors combined with dielectric mirrors) have higher optical efficiency than illumination systems that utilize dichroic mirrors.

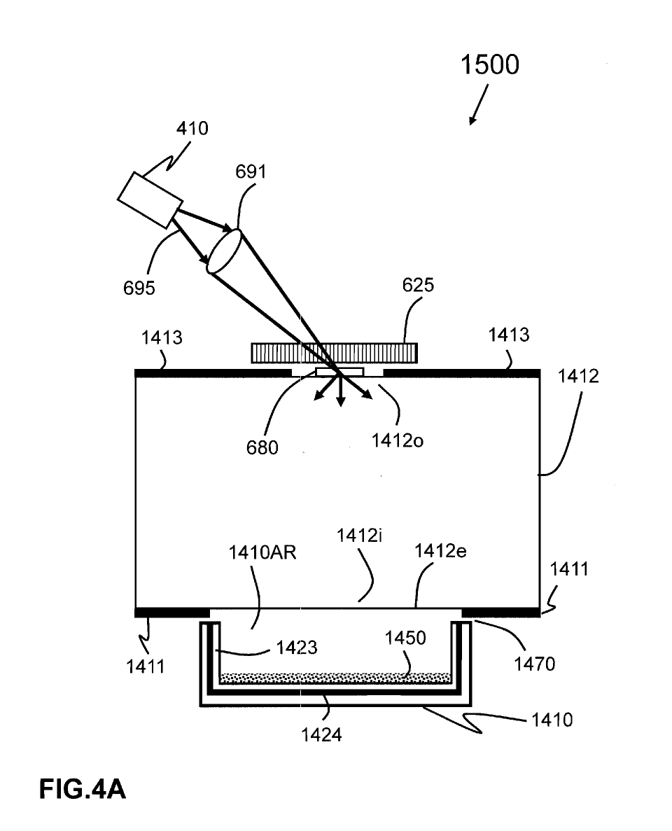

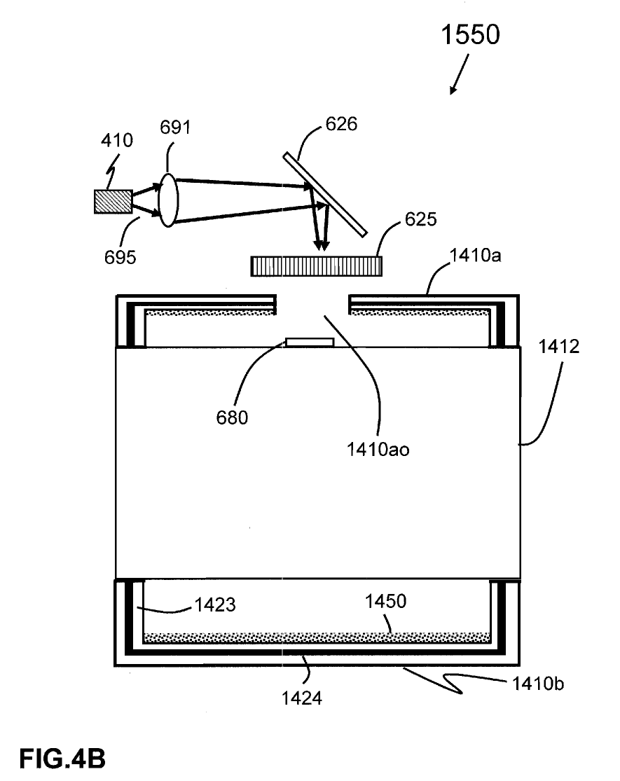

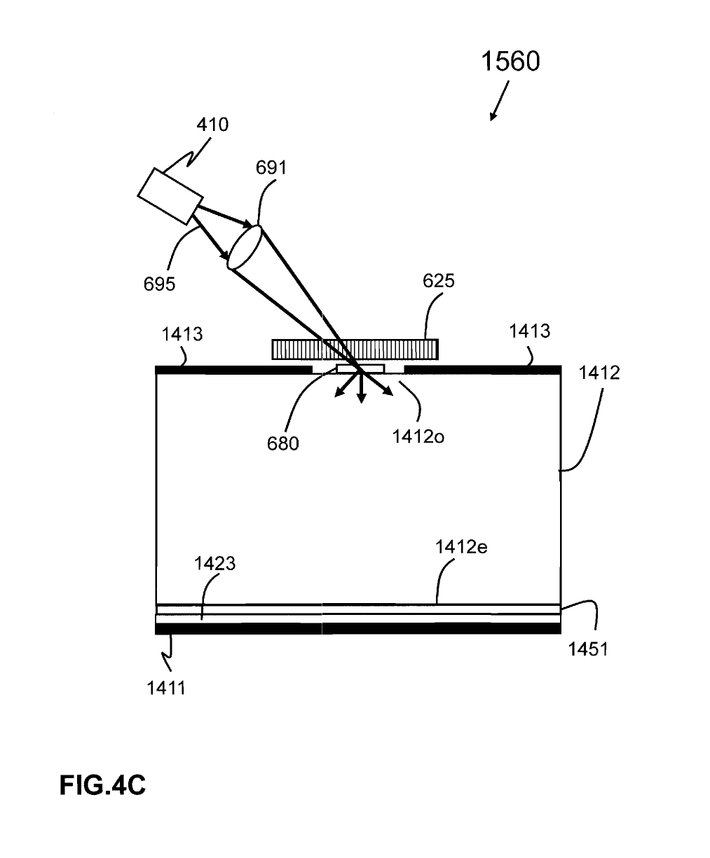

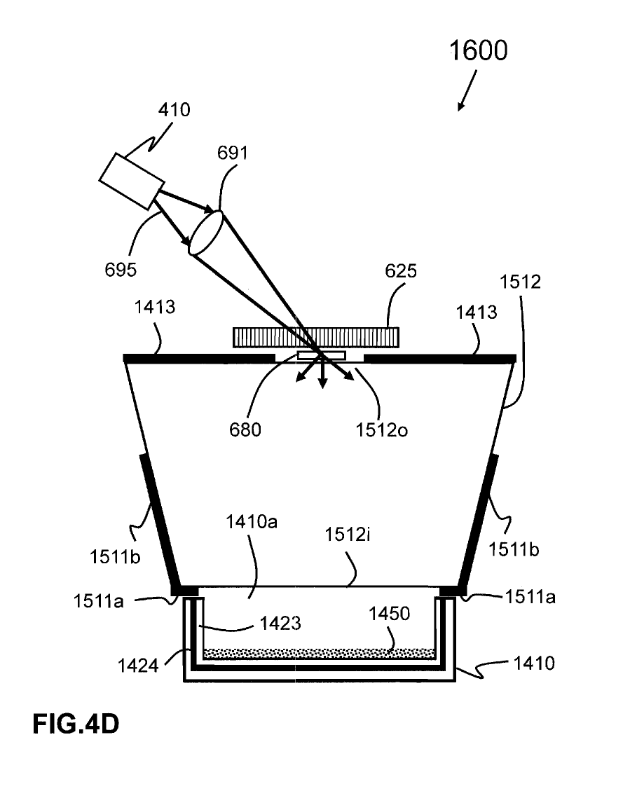

FIGS. 4A-4D show cross-sectional views of exemplary light sources or illumination assemblies 1500, 1550, 1560 and 1600. In illumination assemblies 1500, 1550, 1560 and 1600, the light envelope comprises at least one solid light guide and at least one hollow light envelope. Light assemblies 1500, 1550 and 1600 have the advantage of lower optical losses due to the use of total internal reflection at the sidewalls of the solid light guide 1412 when compared to illumination systems that use reflections at the envelope sidewalls (assuming that illumination systems in both cases have same or comparable sizes). Illumination system 1500 of FIG. 4A consists of violet laser source 410, lens 691, hollow light envelope 1410, solid light guide 1412, optional optical element 625, optional diffusing element 680, a wavelength conversion layer 1450, and an optional low-refractive index layer 1423 located between the wavelength conversion layer 1450 and the reflective coating 1424. Hollow light envelope 1410 is preferably a straight light envelope with an aperture 1410AR (as shown in FIG. 4A) but it can have any 3-dimensional shape enclosing an interior volume and having an aperture (or array of apertures). Optical element 625 and diffusing element 680 have been described earlier. Light envelope 1410 may be made from a highly reflective material and/or may have a reflective coating 1424 applied to its interior surface. When light envelope 1410 is made of an optically transparent material, exterior surface of the light envelope 1410 can be coated with a reflective coating. Solid light guide 1412 has a reflective coating 1411 applied to its entrance aperture except for an input aperture 1412i matching the aperture 1410AR of light envelope 1410 and has a reflective coating 1413 applied to its exit aperture except for an aperture 1412o. A low-refractive index layer (e.g., air gap) is preferably maintained between wavelength conversion layer 1450 and the input aperture 1412i of solid light guide 1412. Light envelope 1410 and solid light guide 1412 are preferably attached together so that a small (or no) gap 1470 exists between them, thus, leading to little or no light losses through the contact area. It is preferable to maintain an air gap between the wavelength conversion layer 1450 and the solid light guide 1412 entrance surface 1412e, otherwise, a reflective coating has to be applied to the sidewalls of the solid light guide 1412 in order to prevent light losses.

The light envelope 1410 and solid light guide 1412 of illumination system 1500 may have cross-sections with equal sizes. In this case, the reflective coatings 1411 are preferably removed.

Illumination system 1550 of FIG. 4B consists of a violet laser source 410, optional lens 691, optional dichroic mirror 626, hollow light envelopes 1410a and 1410b, solid light guide 1412, optional optical element 625, optional diffusing element 680, a wavelength conversion layer 1450, and an optional low-refractive index layer 1423 located between the wavelength conversion layer 1450 and the reflective coating 1424. Hollow light envelope 1410a has a single aperture 1410ao for inputting violet laser light and outputting converted light. It is also possible to use a separate input aperture made in hollow light envelope 1410a or envelope 1410b for inputting the violet laser light into the illumination system 1550 while using aperture 1410ao for outputting the converted light.

Light source or illumination assembly 1560 of FIG. 4C consists of a violet laser source 410, optional lens 691, solid light guide 1412, optional optical element 625, optional diffusing element 680, a wavelength conversion layer 1451, and an optional low-refractive index layer 1423 located between the wavelength conversion layer 1451 and the reflective coating 1411. The wavelength conversion layer 1451 is applied directly to the entrance surface 1412e of solid light guide 1412. Since no air gap exists between the wavelength conversion layer 1451 and the entrance surface 1412e of solid light guide 1412, the sidewalls of solid light guide 1412 will have to be coated with a reflective coating to prevent light leakage from the sidewalls of the solid light guide 1412.

Light source or illumination assembly 1600 of FIG. 4D consists of a violet laser source 410, lens 691, hollow light envelope 1410, solid light guide 1512, optional optical element 625, optional diffusing element 680, a wavelength conversion layer 1450, and an optional low-refractive index layer 1423 located between the wavelength conversion layer 1450 and the reflective coating 1424. Solid light guide 1512 has a reflective coating 1511b applied to part of its tapered sidewalls, a reflective coating 1511a applied to its entrance aperture except for an input aperture 1512i that receives light from light envelope 1410, and a reflective coating 1413 applied to its exit aperture except for an aperture 1512o that delivers light to an optional optical element 625.

A micro-guide plate and/or collimation element may be utilized with illumination assemblies 1500, 1550, 1560 and 1600. Micro-guide plates can be of any type such as the brightness enhancement films made by 3M or the ones described later in this disclosure. Collimation element can be a lens, group of lenses, solid or hollow compound parabolic concentrator (CPC), solid or hollow light guide with tapered sidewalls, a CPC or a tapered solid or hollow light guide followed by a hollow/solid light guide with straight sidewalls. The function of collimation element is to at least partly collimate and/or homogenize the received light. This means that light delivered by the collimation element is more collimated and/or uniform than light received by the collimation element.

Each of illumination assemblies 1500, 1550, 1560 and 1600 can have more than one input aperture 1412i, 1512i and more than output aperture 1412o, 1410ao, 1512o. Each of the input apertures can be attached to its own light envelope and wavelength conversion material.

Each of illumination assemblies 1500, 1550, 1560 and 1600 may have a dedicated input aperture that receives the light from the excitation light source. The input aperture is made at any selected location (excluding the area of the output aperture 1412o, 1410ao, 1512o) on the surface of the light envelope 1410b and 1410 or solid light guide 1412 and 1512. In this case, the output light exits through the output aperture 1412o, 1410ao, 1512o.

Each one of illumination assemblies of FIGS. 2-4 may comprise an array of light envelopes with the associated light sources, lenses, solid light guides, collimating optics and optical elements. The wavelength conversion material of each light envelope in the array can have a selected wavelength conversion material (e.g., red, yellow, green, blue or cyan phosphors) to deliver light in a selected waveband (e.g., red, yellow, green, blue or cyan wavebands) upon excitation. For example, an illumination assembly can have three light envelopes and each envelope has a different type of phosphor (e.g., red, green or blue phosphors). The three phosphors can be excited by one light source (with a scanning or switching mechanism to sequentially excite the different phosphors) or three light sources (one source is dedicated for each assembly).

Illumination assemblies 1500, 1550 and 1600 have the advantage of utilizing total internal reflection at the sidewalls of solid light guides 1412 and 1512 and, thus, providing less optical losses when compared to illumination systems that apply metallic and/or dielectric reflective coatings to the sidewalls of hollow or solid light guides. As the amount of recycled light within a system is increased, more optical reflections occur resulting in more optical losses especially when reflections occur via metallic (or metallic combined with dielectric) coatings. Since reflections via total internal reflection have low or no optical losses, utilizing solid light guides 1412 and 1512 for light recycling leads to lower optical losses as long as the absorption losses of the solid light guide materials 1412 and 1512 are low enough. Example of a material that has very low optical absorption in the visible wavelength range is the commercially available UV grade fused silica.

Illumination assemblies 1500, 1550, 1560 and 1600 can utilize any number of light envelopes with different wavelength conversion layers (e.g., two, three, four, five or more types of phosphors). In addition, illumination assemblies 1500, 1550, 1560 and 1600 can utilize a low-refractive index layer applied to the input aperture 1412i and 1512i or located next or in close proximity to the input aperture 1412i and 1512i.

Light sources and illumination assemblies 4500, 4600, 4700, 5500, 6500, 6600, 6700, 6800, 6900, 7000, 1500, 1550, 1560 and 1600 may utilize transverse multimode violet laser diodes as a laser source. Transverse multimode violet laser diodes are more efficient laser diodes when compared to single mode and fundamental transverse mode violet laser diodes.

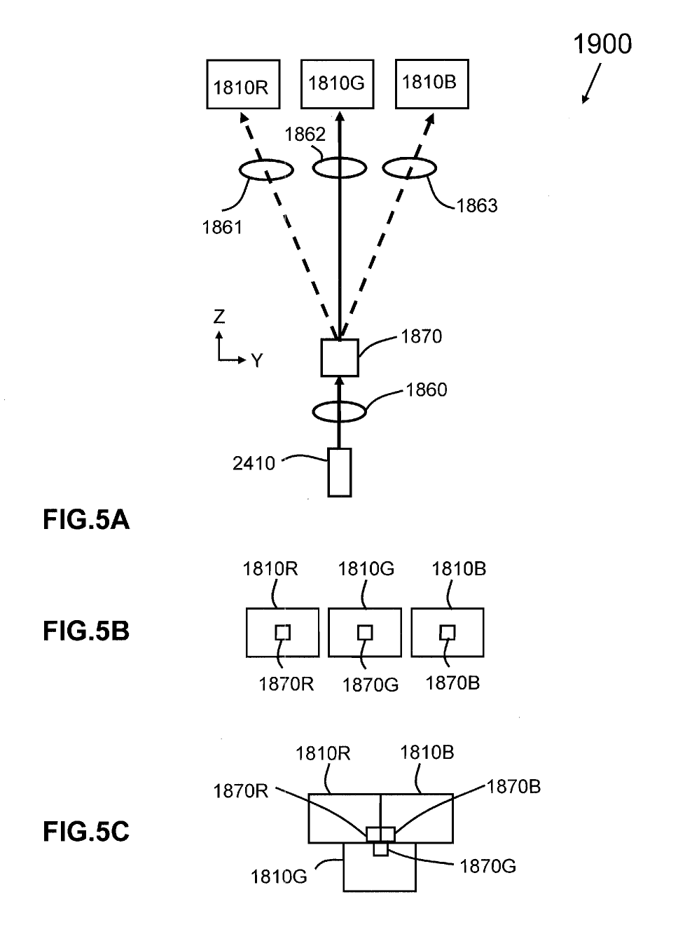

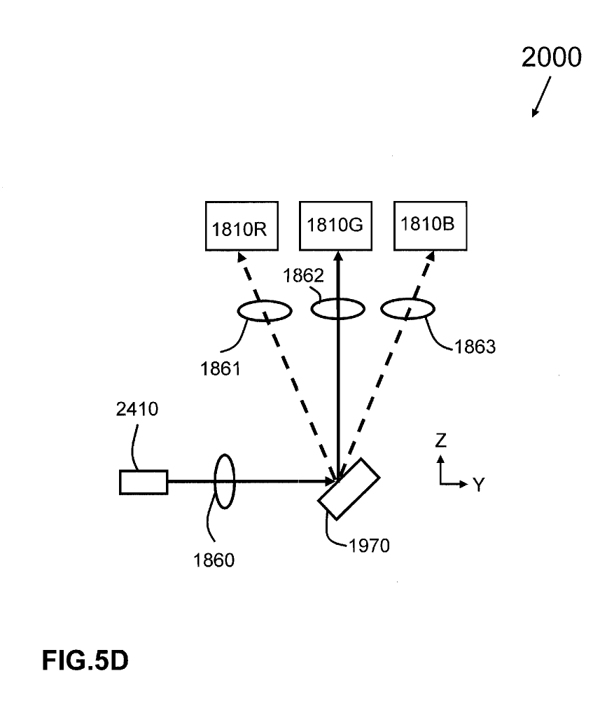

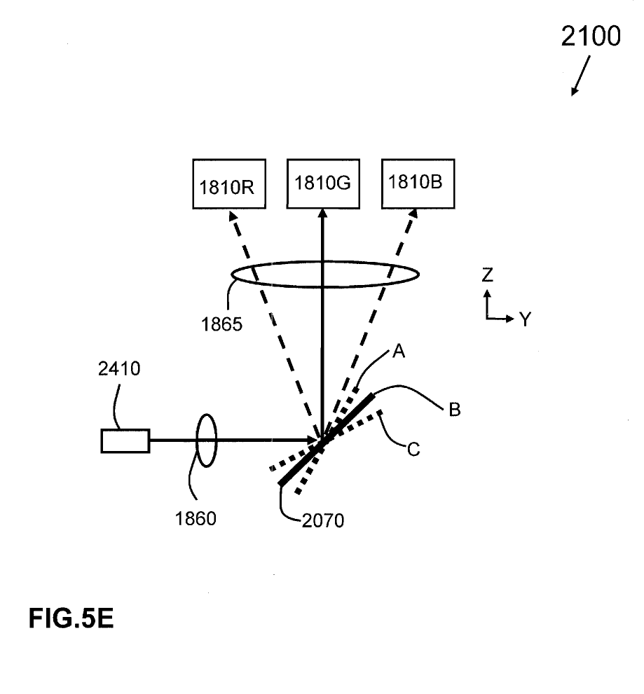

FIGS. 5A, 5D and 5E show cross-sectional views of exemplary illumination systems 1900, 2000 and 2100. Illumination systems 1900, 2000 and 2100 utilize transmissive and reflective deflectors 1870 and 1970, respectively, as well as a single light source 2410 for the sequential excitation of the wavelength conversion materials of three light envelopes 1810R, 1810G, and 1810B. As shown in FIGS. 5A and 5D, illumination systems 1900 and 2000 consist of a violet laser source 2410, optional lenses 1860, 1861, 1862 and 1863, deflectors 1870 and 1970 and three light envelopes 1810R, 1810G and 1810B that utilize three wavelength conversion materials (e.g., red, green and blue phosphors) to deliver light in three wavebands (e.g., red, green and blue wavebands). The function of the transmissive and reflective deflectors 1870 and 1970 is to sequentially deflect or switch the light beam received from the source 2410 between the clear openings (i.e., aperture) 1870R, 1870G, and 1870B of illumination assemblies 1810R, 1810G, and 1810B. The duty cycle of the light source can be synchronized with the deflector movement to control the output light of illumination system 1900 and 2000. The sequence of switching the source light between various illumination assemblies, amount of electrical power supplied to light source and time spent in inputting light to each illumination assembly can be changed as needed at any time during the operation. At least one photo-detector can be added to any of the illumination assemblies and systems of this disclosure to sense the amount of outputted light by an illumination assembly or system (e.g., a photo-detector per wavelength range). A feedback signal is then used to adjust the amount of electrical power supplied to a light source and time spent in inputting light to an illumination assembly in order to deliver a certain amount of light at a given time for a given application according to a selected time sequence.

A deflector is a device capable of changing the path of a light beam, moving a light beam from one location to another while maintaining its path, or a combination of both (i.e., changing the path of a the light beam and moving the light beam). For example, a light source (or output end of an optical fiber guiding a light beam) can be rotated physically to change the path of its light beam, subjected to a translational movement (with no rotational movement) to change the location of its light beam, or subjected to a combination of rotational and translational movements.

The transmissive and reflective deflector 1870 and 1970 can be a holographic scanner, an acousto-optic deflector, an electro-optic deflector, a galvanometer scanner, a rotating polygonal minor, thermo-optic deflector, a semiconductor optical amplifier switch or a mechanical switch. Example of a mechanical switch include a minor that moves in and out of an optical path in order to provide the switching or deflection function, a directional coupler that couples light from an input port to different output ports by bending or stretching a fiber in the interaction region, an actuator that tilts or moves the output end of a fiber between different output ports, an actuator that tilts or moves the light source itself to provide the switching function, and a mirror that is magnetically, piezo-electrically, electro-magnetically, or thermally actuated. An electro-optic switch utilizes the change in the refractive index of an electro-optic material (e.g., Lithium niobate) as a function of applied voltage in order to provide the switching. A thermo-optic switch utilizes the change in the refractive index of a material as a function of temperature in order to provide the switching (e.g., Mach-Zehnder interferometers). A semiconductor optical amplifier switch can be used as on-off switch by varying the bias voltage applied to the device. When the bias voltage is applied the device amplifies the input signal, however, when the bias voltage is reduced no population inversion occurs and the device absorbs input signal.

In addition, a deflector can be an electrically, magnetically, piezo-electrically, electro-magnetically, or thermally actuated micro-mirror. Examples of such micro-minors include micro-electro-mechanical system (MEMS) based micro-mirrors. Micro-mirrors are integrated devices where the micro-minor and actuator are made together as an integrated device using same fabrication process while conventional minors utilize external actuators that are made separately and then get assembled together with the minors. Each of the optional lenses 1860, 1861, 1862 and 1863 can be a single lens or set of lenses, which are used, for example, to focus the light beam. As shown in FIG. 5E, the three lenses 1861, 1862 and 1863 can be replaced by one set of lenses 1865 that consists of one or more lenses. Each of light envelopes 1810R, 1810G and 1810B can be selected from light envelopes discussed in this disclosure such as light envelopes of illumination systems 4500, 4600, 4700, 5500, 6500, 6600, 6700, 6800, 6900, 7000, 1500, 1550, 1560 and 1600 shown in FIGS. 2-4.

A deflector 1870 can be used to scan a light beam between two or more (e.g., three, four, five, six, etc.) types of wavelength conversion materials. The light beam can interact with the wavelength conversion materials directly or transmitted to the wavelength materials through other means (e.g., light guide, optical fiber, diffuser, mirror, collimating optics, light-recycling envelope, prism or optical coating). As shown in FIG. 5B-5C, light envelopes with their corresponding wavelength conversion materials can be arrayed next to each other or in any selected configuration (e.g., line, triangular, circular, square, oval, rectangular or irregular). The clear openings can be placed close to each other as shown in FIG. 5C or apart from each other as shown in FIG. 5B. The wavelength conversion material can be placed on a reflective surface (e.g., a minor with a flat surface, light-recycling envelope with reflective surfaces, or a mirror with any shape) with an optional low-refractive index layer in between. Alternatively, the wavelength conversion material can be located on a reflective polarizer, dichroic minor, a dichroic cube, diffractive optical element, micro-refractive element, brightness enhancement film, hologram, a filter that blocks (absorbs and/or reflects) a certain wavelength, a photonic crystal or a combination of two or more of these elements. For example, the wavelength conversion material can partly or completely fill a hollow light guide having internal (or external) reflective surfaces with an optional low-refractive index layer located between the wavelength conversion material and the reflective surfaces. Alternatively, the wavelength conversion material can partly or completely cover the internal surfaces (without necessarily filling the whole interior volume) of a hollow light guide having internal (or external) reflective surfaces with an optional low-refractive index layer located between the wavelength conversion material and the reflective surfaces.

A deflector 1870 can be used to scan a light beam between two or more (e.g., three, four, five, six, etc.) light envelopes with each having at least one wavelength conversion material. Examples of such light envelopes include light envelopes discussed by Nagahama et al. in U.S. patent application Ser. No. 11/702,598 (Pub. No.: US20070189352), light envelopes discussed by Beeson et al. in U.S. Pat. Nos. 7,040,774 and 7,497,581 and light envelopes discussed by Harbers et al. in U.S. Pat. Nos. 7,070,300 and 7,234,820. It is also possible to use a deflector to switch light beam between two or more wavelength conversion materials in any of the illumination systems discussed by Harbers et al. in U.S. Pat. Nos. 7,070,300 and 7,234,820 assuming that that each of such illumination systems has two or more wavelength conversion materials.

The violet laser source 2410 and the deflector 1870, 1970 and 2070 can be oriented at any angle with respect to the optical axis (i.e., Z-axis) of the illumination system 1900, 2000 and 2100. For example, the violet laser source 2410 and the deflector 1870 are both aligned with the optical axis (i.e., Z-axis) of the illumination system 1900 as shown in FIG. 5A. In FIGS. 5D and 5E, the violet laser source 2410 is oriented at 90 degrees with the optical axis (i.e., Z-axis) of the illumination systems 2000 and 2100 and the deflectors 1970 and 2070 are oriented at 45 degrees with the optical axis (i.e., Z-axis) of the illumination systems 2000 and 2100.

FIG. 5E shows a cross-sectional view of illumination system 2100, which is the same as illumination system 2000 except for the use of a minor or micro-mirror 2070 as a deflector and lens (or set of lenses) 1865. The minor or micro-mirror 2070 tilts between positions A, B and C and the received light beam is directed between illumination assemblies 1810R, 1810G and 1810B, respectively. The light beam (and light source) can be oriented at any angle with respect to the optical axis of the illumination system 2100, which is parallel to the Z-axis.

Each input aperture in an illumination assembly or system of this disclosure can receive a portion of the light emitted from the laser source. In this case, the light emitted from a laser is divided into two or more sub-beams (using for example beam splitters) that are then coupled to two or more input apertures in an illumination assembly. It is also possible to use a deflector to switch a light beam (or sub-beam) in and out of a input aperture or to switch a light beam between two or more input apertures according to any selected sequence. The switch or deflector provides control over which type of wavelength conversion layer is excited at a given time. For example, light from one laser source can be divided into three sub-beams, which are then utilized to continuously or sequentially excite three types of phosphors (e.g., red, green and blue phosphors in an illumination system) through the use of deflectors and deliver three colors for display applications. Each sub-beam can be controlled by a dedicated deflector or an optical attenuator in order to adjust or attenuate the sub-beam light and, thus, control the amount of converted light.

Illumination systems 1900, 2000 and 2100 that utilize the deflector described in this disclosure has the advantage of using a single violet laser source to excite the wavelength conversion materials (e.g., red, green and blue phosphors) of more than one light envelope, thus, leading to simplified and compact illumination systems as well as reduced costs.

The output optical power of a light source 410 and 2410 can be adjusted (by varying the electrical power of the light source as a function of time) to control the flux of the light source and the corresponding flux of converted light. When more than one wavelength conversion material is utilized in an illumination system (each with a corresponding light source), the color of output light (mixture of light beams from all or part of utilized wavelength conversion materials) can be adjusted as a function of time by adjusting the relative electrical powers of the light sources as a function of time. In addition, the color rendering index (a measure of the quality of the white light emitted by an illumination assembly or system when compared to a reference illumination source having a color rendering index of 100) of an illumination system producing white light can be controlled by adjusting the relative electrical powers of the light sources utilized in the illumination system. In illumination systems 1900, 2000 and 2100 that utilize one laser source 2410 with a deflector 1870, 1970 and 2070, the color of output light (which is not necessarily white light) or the color rendering index of white output light can be controlled by adjusting the electrical power of the light source as it moves from one illumination assembly 1810R, 1810G and 1810B to another 1810R, 1810G and 1810B. Illumination systems that utilize a single violet laser source with a deflector provide more stable color rendering index with time (even if output light of the light source is not controlled as a function of time) since the variation or decline of output light equally impacts the two or more wavelength conversion materials utilized in the corresponding light envelopes to produce white light. This is true as long as the variation or decline is a long term decline (usually happens over days, months or even years) and not a variation or decline occurring over a short period of time (e.g., sub-millisecond or millisecond range).

The reflectivity of the reflective coating used is preferably at least 50%, more preferably at least 90% and most preferably at least 99%.

The optically transmissive light guides can be made of glass such as UV grade fused silica, which has low optical losses especially in the visible waveband. The opaque light guide and the heat sink can, for example, be made of silicon, silver, aluminum, copper, diamond, nickel, silicon carbide, zirconia, alumina, aluminum nitride, barium sulfate, carbon, stainless steel, borosilicate glass, or the like. It is preferable to use a light guide 4112, 4112b, 4112c, 420, 520, 620 and 1410 that has a thermal expansion coefficient equal to that of the wavelength conversion layer 4124, 413, 513, 613, 813, 913 and 1450 in order to prevent defects, which occur due to mismatch in the thermal expansion coefficients of the wavelength conversion layer 4124, 413, 513, 613, 813, 913 and 1450 and the light guide 4112, 4112b, 4112c, 420, 520, 620 and 1410.

The clear aperture 4114, 412, 512, 620a, 850, 950, 1412o, 1412i, 1410ao, 1512o, 1512i, 1870R, 1870G and 1870B can have any shape such as a square, rectangular, circular, oval and arbitrary faceted or curved shape. The area of an output aperture can range from 0.01 mm² to tens of mm² and more preferably from 0.05 mm² to few mm².

In other configurations, a collimation element can be utilized in any of illumination systems 4500, 4600, 4700, 5500, 6500, 6600, 6700, 6800, 6900, 7000, 1500, 1550, 1560, 1600, 1900, 2000 and 2100 to collimate and/or homogenize at least part of the light exiting the system 4500, 4600, 4700, 5500, 6500, 6600, 6700, 6800, 6900, 7000, 1500, 1550, 1560, 1600, 1900, 2000 and 2100. The collimation element can be a lens, group of lenses, fly's eye lens plates, a solid compound parabolic concentrator (CPC) that guides light via total internal reflection and/or reflection, a hollow compound parabolic concentrator (CPC) that guides light via reflection, a solid light guide with tapered sidewalls that guides light via total internal reflection and/or reflection, a hollow light guide with tapered sidewalls that guides light via reflection, a solid/hollow CPC followed by a hollow/solid light guide with straight sidewalls, a tapered solid/hollow light guide followed by a hollow/solid light guide with straight sidewalls, or a combination of such elements.

The heat sink can be a combination of a plurality of elements of various shapes. For example, the heat sink may have the function of supporting the light guide 4112, 4112b, 4112c, 420, 520, 620 and 1410.

A laser diodes outside the violet wavelength range of 405±45 nm may be utilized as excitation sources for light sources and illumination systems of this disclosure. These laser diodes include blue lasers that emit in the wavelength ranges of 450-490 nm, UV lasers that emit in the wavelength range of 200-360 nm and laser diodes that emit in a range of 490-3000 nm.

FIGS. 6-9 show perspective and cross-sectional views of collimating plates 150, 160, 170 and 180, which can be used with any of the illumination systems 4500, 4600, 4700, 5500, 6500, 6600, 6700, 6800, 6900, 7000, 1500, 1550, 1560, 1600, 1900, 2000 and 2100 of this disclosure. For example, each collimating plate 418, 518, 818 and 918 of FIG. 3 can be selected from collimating plates 150, 160, 170 and 180 of FIGS. 6-9.

FIG. 6A is a detailed perspective view of a collimating plate 150. Collimating plate 150 includes an aperture plate 34a, micro-guide array 34b and a micro-lens array 34c. Each micro-lens corresponds to a micro-guide and a micro-aperture. As shown in FIG. 6D, the aperture array 34a includes a plate made of a transmissive material 34a1 that is highly transmissive at the desired wavelength. The top surface of the plate has a patterned, highly reflective coating 34a2 applied thereto.

A perspective view of the micro-guide 34b and micro-lens 34c arrays is shown in FIG. 6C. Both arrays 34b and 34c are made on a single glass plate. A cross-sectional view of the aperture 34a, micro-guide 34b and micro-lens 34c arrays is shown in FIG. 6B. In applications were maintaining the polarization state of the light is important, sidewalls of the micro-guides within the micro-guide array 34b can be oriented so that the polarization state of the light entering and exiting the micro-guide array 34b is maintained.

Design parameters of each micro-element (e.g., micro-guide, micro-lens or micro-tunnel) within an array 34a, 34b and 34c include shapes and sizes of entrance and exit apertures, depth, sidewall shapes and taper, and orientation. Micro-elements within an array 34a, 34b and 34c can have uniform, non-uniform, random or non-random distributions and can range in number from one micro-element to millions, with each micro-element capable of being distinct in its design parameters. The size of the entrance/exit aperture of each micro-element is preferably >5 μm, in applications using visible light in order to avoid light diffraction phenomenon. However, it is possible to design micro-elements with sizes of entrance/exit aperture being <5 μm. In such applications, the design should account for the diffraction phenomenon and behavior of light at such scales to provide homogeneous light distributions in terms of intensity, viewing angle and color over a certain area. Such micro-elements can be arranged as a one-dimensional array, two-dimensional array, circular array and can be aligned or oriented individually. In addition, the collimating plate 150 can have a smaller size than the aperture 4114, 412, 512, 620a, 850, 950, 1412o, 1512o, 1870R, 1870G and 1870B of the illumination system and its shape can be rectangular, square, circular or any other arbitrary shape.

The operation of the collimating plate 150 is described as follows. Part of the light impinging on the collimating plate 150 enters through the openings of the aperture array 34a and the remainder is reflected back by the highly reflective coating 34a2. Light received by the micro-guide array 34b experiences total internal reflection within the micro-guides and becomes highly collimated as it exits array 34b. This collimated light exits the micro-lens array 34c via refraction as a more collimated light. In addition to this high level of collimation, collimating plate 150 provides control over the distribution of delivered light in terms of intensity and cone angle at the location of each micro-element.

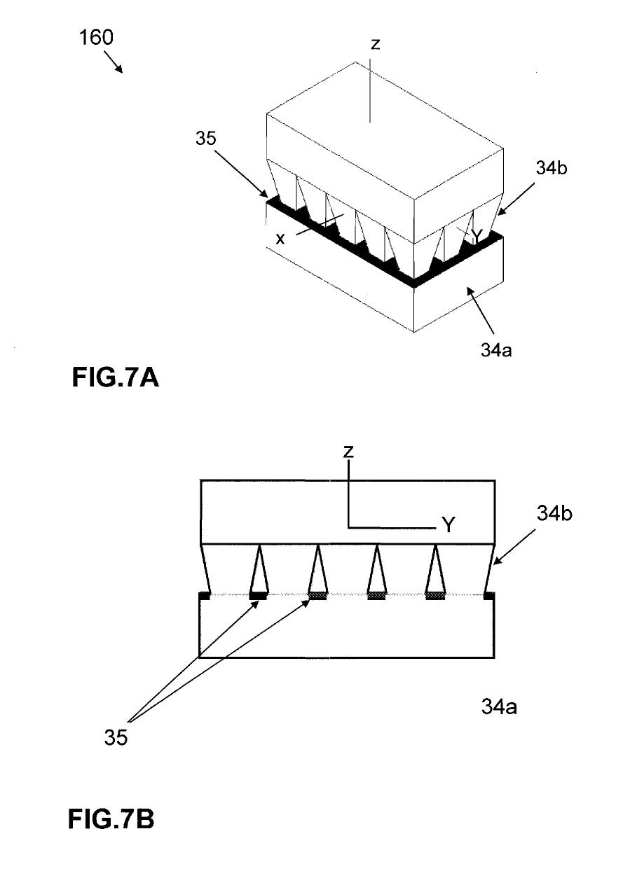

FIGS. 7A-7B show perspective and cross-sectional views of an alternative collimating plate 160 that can be used with any of the light sources and illumination systems 4500, 4600, 4700, 5500, 6500, 6600, 6700, 6800, 6900, 7000, 1500, 1550, 1560, 1600, 1900, 2000 and 2100 of this disclosure. The collimating plate includes a micro-guide array 34b and an aperture array 34a with a reflective coating on their edges.

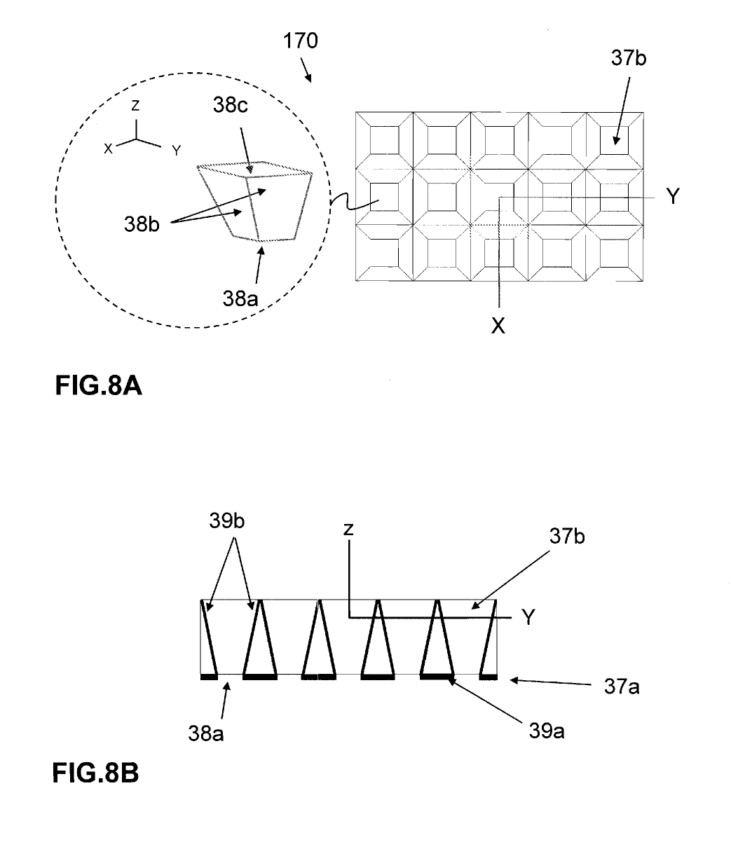

FIGS. 8A-8B show top and cross-sectional views of another alternative collimating plate 170 that can be used with any of the light sources and illumination systems 4500, 4600, 4700, 5500, 6500, 6600, 6700, 6800, 6900, 7000, 1500, 1550, 1560, 1600, 1900, 2000 and 2100 of this disclosure. The collimating plate 170 includes a hollow micro-tunnel array 37b and an aperture array 37a. The internal sidewalls 38b (exploded view of FIG. 8A) of each micro-tunnel are coated with a highly reflective coating 39b (FIG. 8B). Part of the light impinging on collimating plate 170 enters the hollow micro-tunnel array 37b and gets collimated via reflection. The remainder of this light gets reflected back by the highly reflective coating 39a of aperture array 37a. The advantages of collimating plate 170 are compactness and high transmission efficiency of light without the need for antireflective (AR) coatings at the entrance 38a and exit 38c apertures of its micro-tunnels.

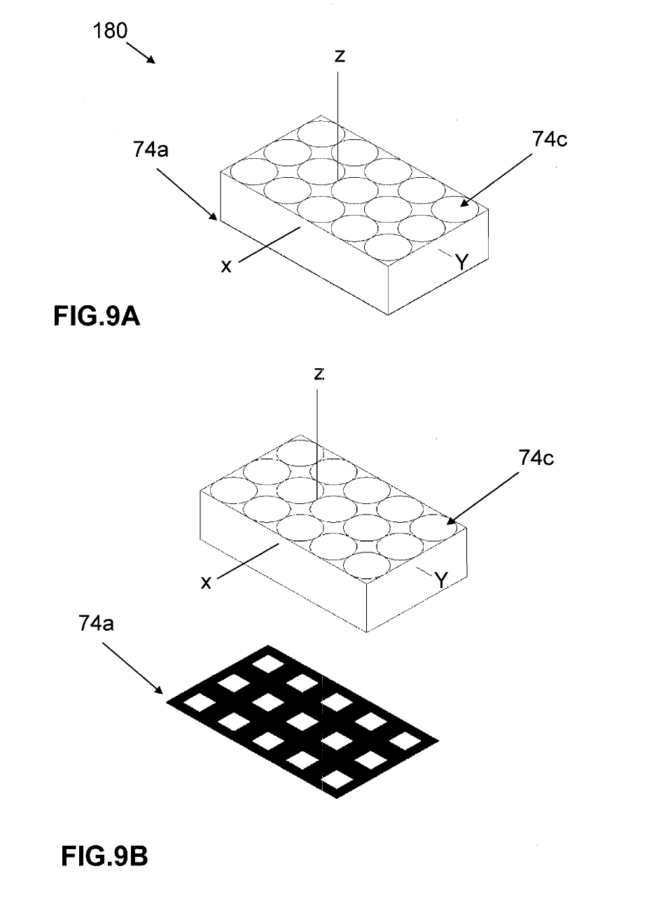

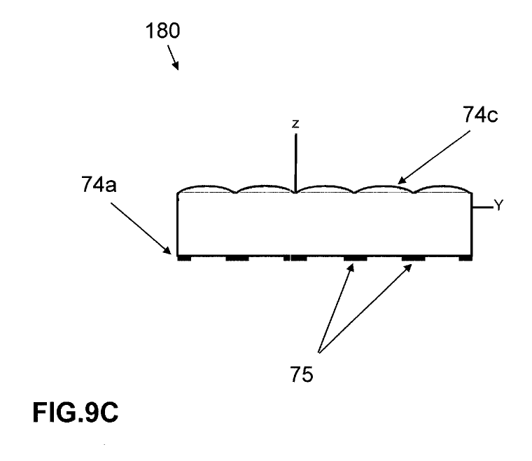

FIGS. 9A-9C show perspective (integrated and exploded) and cross-sectional views of another alternative construction of a collimating plate 180 that can be used with any of the light sources and illumination systems 4500, 4600, 4700, 5500, 6500, 6600, 6700, 6800, 6900, 7000, 1500, 1550, 1560, 1600, 1900, 2000 and 2100 of this disclosure. The collimating plate 180 includes an aperture array 74a and an optional micro-lens array 74c made on a single plate. In collimating plate 180, the micro-lens array 74c performs the collimation function of delivered radiation via refraction. The aperture array 74a can be deposited directly on the exit face of a solid light guide 1412 and 1512.

Additional details of the construction, manufacture and operation of collimating plates, such as example collimating plates 150, 160, 170 and 180, are given in related U.S. Pat. Nos. 7,306,344; 7,318,644; and 7,400,805, which are incorporated herein by reference.

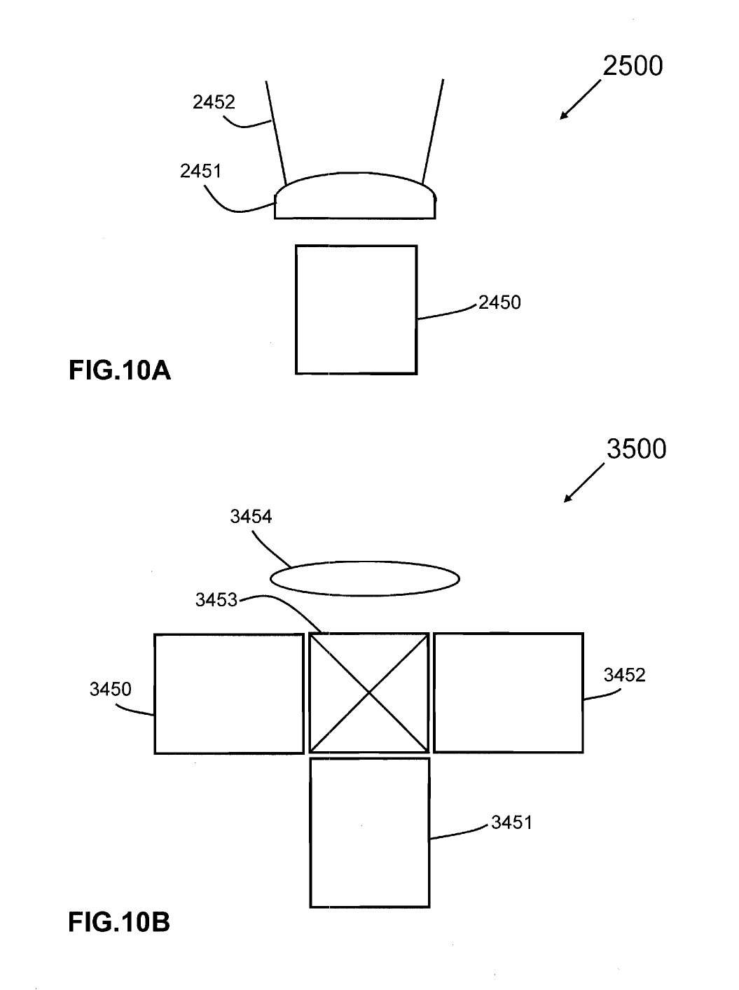

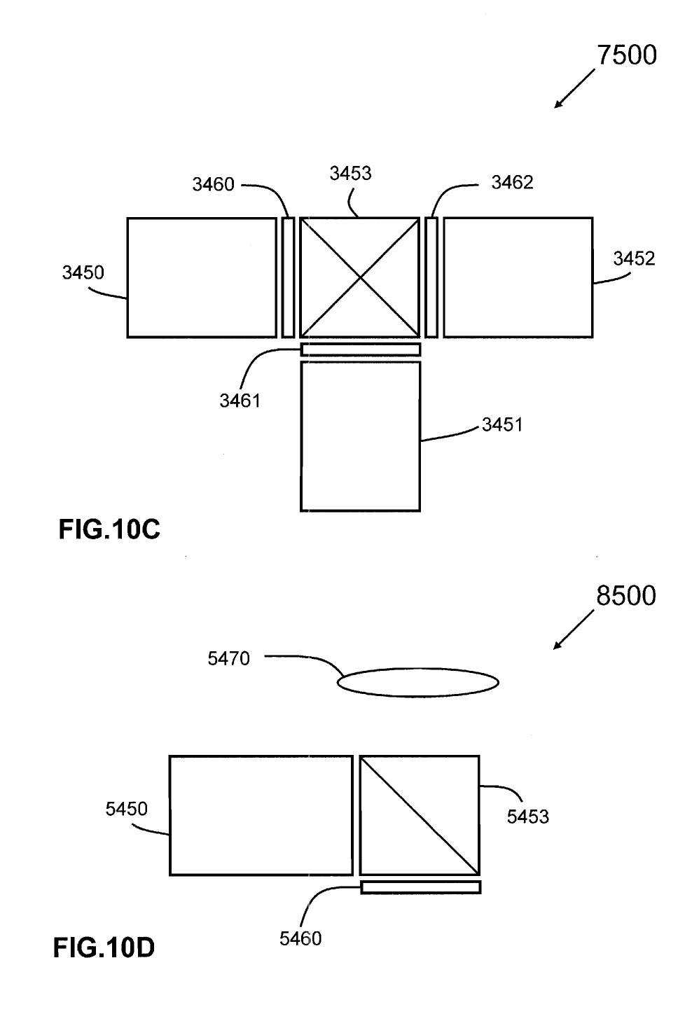

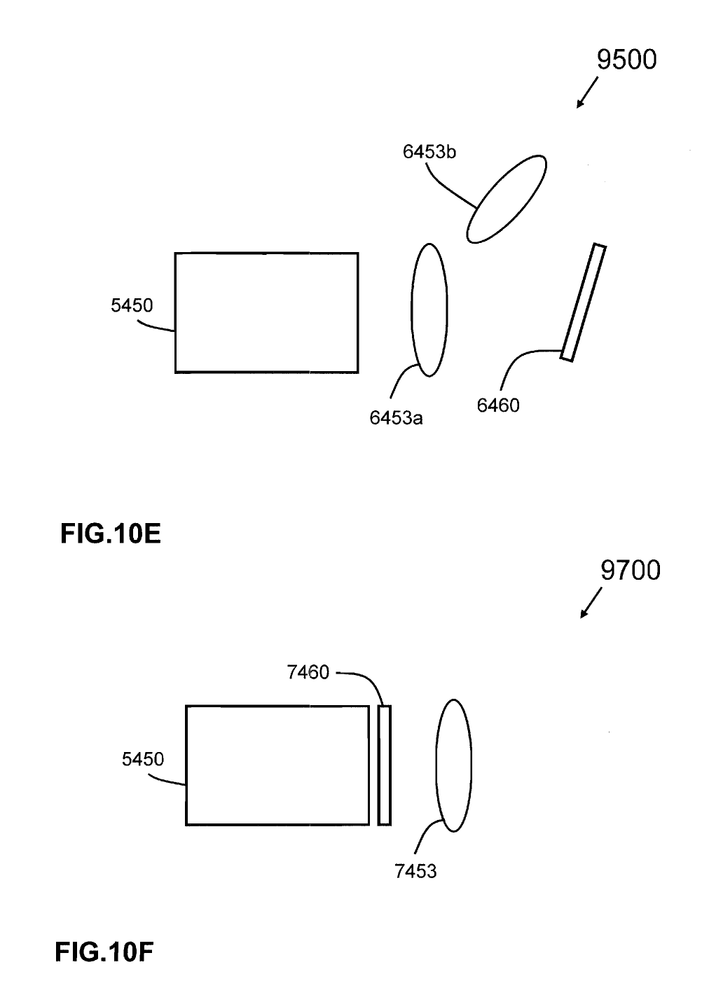

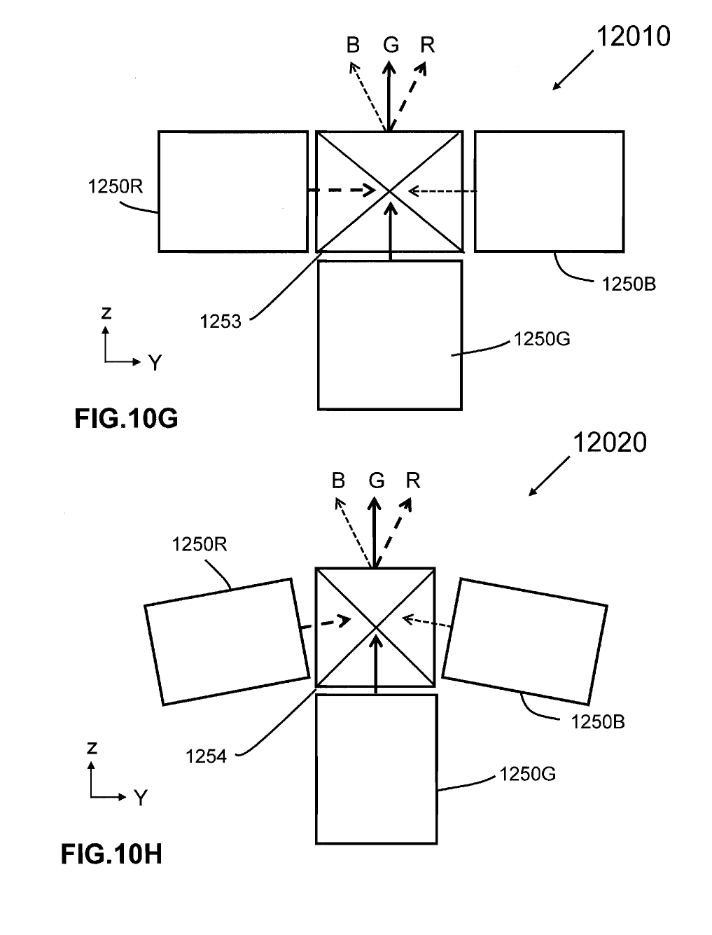

FIG. 10A shows a cross-sectional view of an illumination apparatus 2500 that utilizes a projection lens 2451 and an illumination system 2450 to deliver a light beam 2452. Illumination system 2450 can be selected from any of the illumination systems of this disclosure. For example, illumination apparatus 2500 can be used as an automobile headlight or as a spot light.

FIG. 10B shows a cross-sectional view of a projection system 3500 that includes a plurality of illumination systems 3450, 3451 and 3452, an X-plate 3453, an optional relay lens 3454, a micro-display (not shown), a projection lens (not shown), and an optional screen (not shown). Illumination systems 3450, 3451 and 3452 are selected from the light sources and illumination systems 4500, 4600, 4700, 5500, 6500, 6600, 6700, 6800, 6900, 7000, 1500, 1550, 1560, 1600, 1900, 2000 and 2100 of this disclosure and may include a collimation element in their architecture to deliver collimated light (e.g., red, green and blue) to the X-plate. The X-plate 3453 and relay lens 3454 are utilized to combine the output light beams from illumination assemblies 3450, 3451 and 3452 and deliver the combined beams to a micro-display (e.g., transmissive HTPS type, transmissive MEMS based panels offered by Pixtronix, Digital Micro-Mirror (DMD) type, and Liquid Crystal on Silicon (LCOS) type), which in turn delivers the beams to a projection lens to project an image onto a screen. The transmissive HTPS micro-display can have a micro-lens array (MLA) in its structure to enhance its optical efficiency or may have a reflective layer replacing (or added to) the black matrix layer to reflect light that impinges on areas outside the pixel aperture back to the illumination assembly for recycling. The transmissive HTPS micro-display (or MEMS based panel made by Pixtronix) can be attached directly to (or placed in close proximity to) the X-plate 3453 without using relay lens 3454. The transmissive HTPS and/or LCOS micro-displays can have a color filter in their architecture while utilizing a single micro-display with white light (or a combination of red, green and blue colors) rather than sequencing three separate colors.

FIG. 10C shows a cross-sectional view of a projection system 7500 that includes a plurality of illumination systems 3450, 3451 and 3452, an X-plate 3453, a plurality of micro-displays 3460, 3461 and 3462, an optional relay lens (not shown), a projection lens (not shown), and an optional screen (not shown). Micro-displays 3460, 3461 and 3462 are of the transmissive type (e.g., High Temperature Poly Silicon (HTPS) micro-displays and MEMS based micro-displays offered by Pixtronix). The X-plate 3453 combines a plurality of light beams received from a plurality of micro-displays 3460, 3461 and 3462 and delivers the combined beams to a projection lens, which in turn projects an image onto a screen.

FIG. 10D shows a cross-sectional view of a compact projection system 8500 that includes an illumination system 5450, relay optics 5453, a micro-display 5460, an optional relay lens 5470, a projection lens (not shown) and an optional screen (not shown). Illumination system 5450 utilizes one assembly (rather than a plurality of assemblies) to provide light with combined colors to a color-sequentially operated micro-display (e.g., Digital Micro-Mirror (DMD) or Liquid Crystal on Silicon (LCOS) micro-display) through relay optics 5453. Relay optics can be a group of total internal reflection (TIR) prisms, a polarizing beamsplitter (PBS), a lens or group of lenses. The LCOS micro-display can have a color filter in its architecture, thus, eliminating the need for the color sequential operation.

FIG. 10E shows a cross-sectional view of a projection system 9500 that includes an illumination system 5450, relay lenses 6453a and 6453b, a reflective micro-display (e.g., DMD type) 6460, a projection lens (not shown) and an optional screen (not shown). This projection system 9500 is a special case of projection system 8500 of FIG. 10D.

FIG. 10F shows a cross-sectional view of a projection system 9700 that includes an illumination system 5450, a transmissive micro-display (e.g., HTPS and MEMS types) 7460, an optional relay lens 7453, a projection lens (not shown) and an optional screen (not shown). The HTPS transmissive micro-display 7460 can have a micro-lens array (MLA) in its structure to enhance the optical efficiency or may have a reflective layer replacing (or added to) the black matrix layer to reflect light that impinges on areas outside the pixel aperture back to the illumination assembly 5450 for recycling. The transmissive micro-display 7460 can be in close proximity or directly attached to illumination assembly 5450. This kind of architecture is discussed in U.S. Pat. No. 7,379,651 to N. Abu-Ageel, titled “Method and Apparatus for Reducing Laser Speckle”, which is incorporated herein by reference. The transmissive micro-display can have a color filter in its architecture, thus, eliminating the need for the color sequential operation.

In certain configurations, a projection system that utilizes a single transmissive liquid crystal micro-display (or transmissive MEMS micro-display based on Pixtronix's technology) and angular color separation method to produce a full color image is used. The architecture of this projection system is similar to that of projection system 9700 except for the use of a micro-display having a micro-lens array and an illumination assembly (such as these of FIGS. 10G and 10H) that produces RGB light beams that are angularly separated. The micro-lens array is arranged so that a single micro-lens is placed over every set of three sub-pixels (red, green and blue). The micro-lens function is to focus the incident red, green, and blue light onto the corresponding aperture of each sub-pixel. A projection system that utilizes this method with a single transmissive liquid crystal micro-display is discussed by L. C. Ling et al. in “An Efficient Illumination System for Single-Panel LCD Projector”, Society for Information Display, Symposium Digest of Technical Papers, 2001, pp. 1184-1187. This document is incorporated herein by reference. FIGS. 10G and 10H show cross-sectional views of illumination assemblies 12010 and 12020 that generate red, green and blue colors at separated angles (e.g., red, green and blue colors are provided at 10±5°, 0±5° and −10±5°, respectively). Illumination assemblies 12010 and 12020 include three (red 1250R, green 1250G and blue 1250B) light sources selected from the light sources of this disclosure and a color cube 1253 to produce red R, green G and blue B colors at separated angles. The angular color separation can be achieved by selecting the appropriate angular orientation of the blue and red dichroic mirrors inside the cube 1253 with respect to the light beams that are received from the light sources. For example, FIG. 10G shows that the blue and red dichroic minors are tilted by certain angles with respect to the blue and red beams that are received from the light sources 1250B and 1250R, respectively, so that color separation is produced. Alternatively, the red and blue light sources 1250R and 1250B can be tilted with respect to dichroic minors within the cube 1253 to produce the angular color separation as shown in FIG. 10H.

Angular color separation may be utilized with the other projection systems of this disclosure that has a single micro-display. In this case, the micro-display (LCOS or DMD type) has to have a micro-lens array in its architecture, which is arranged so that a single micro-lens is placed over every set of three sub-pixels. The micro-lens function is to focus the incident red, green, and blue light onto the corresponding sub-pixel.

Further discussion of illumination (or projection system) architectures is included in U.S. Patent Application No. 60/821,195 to N. Abu-Ageel, titled “LED Based Illumination and Projection Systems”, Attorney Docket No. 24.0013.PZUS00, filed on Aug. 2, 2006, which is incorporated herein by reference.

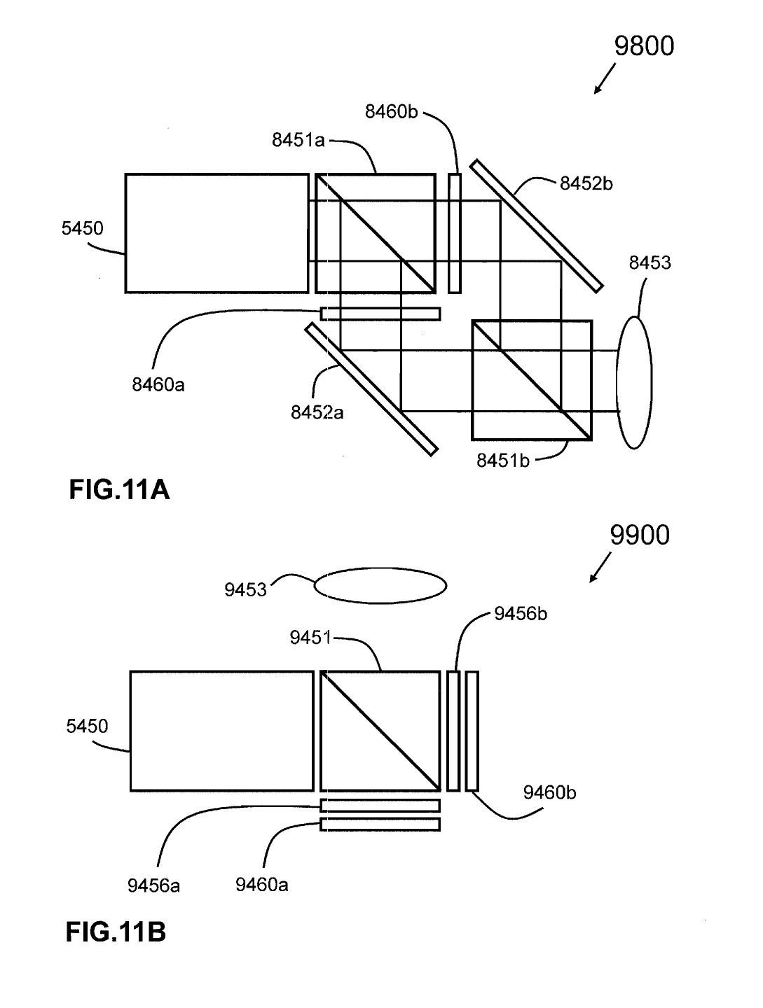

FIG. 11A shows a cross-sectional view of a 2D/3D projection system 9800 that includes an illumination system 5450, polarizing beamsplitters (PBSs) 8451a and 8451b, transmissive micro-displays (e.g., HTPS and MEMS types) 8460a and 8460b, mirrors 8452a and 8452b, an optional relay lens 8453, a projection lens (not shown) and an optional screen (not shown).

FIG. 11B shows a cross-sectional view of a 2D/3D projection system 9900 that includes an illumination assembly 5450, a polarizing beamsplitter (PBS) 9451, reflective micro-displays (e.g., LCOS type) 9460a and 9460b, optional quarter wave plates 9456a and 9456b, an optional relay lens 9453, a projection lens (not shown) and an optional screen (not shown). Other architectures of 1D/2D/3D illumination systems (or projection systems) can utilize illumination systems of this disclosure including the ones discussed in U.S. Pat. No. 7,270,428 to Alasaarela et al., titled “2D/3D Data Projector”, which is incorporated herein by reference.

Illumination assembly 5450 of FIGS. 10D-10F and FIGS. 11A-11B can be selected from illumination systems 4500, 4600, 4700, 5500, 6500, 6600, 6700, 6800, 6900, 7000, 1500, 1550, 1560, 1600, 1900, 2000 and 2100 (e.g., utilizing red, green and blue phosphors to provide a combined red, green and blue colors) of this disclosure and may include a collimation element in their architecture to deliver collimated light (e.g., white light consisting of red, green and blue colors) to the micro-display.

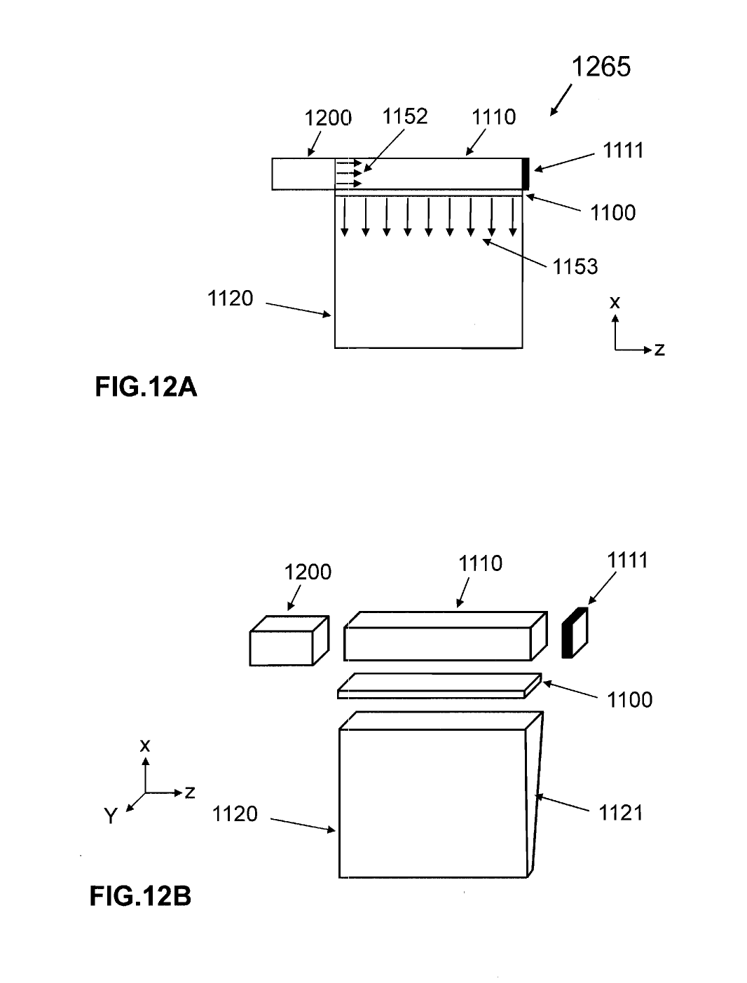

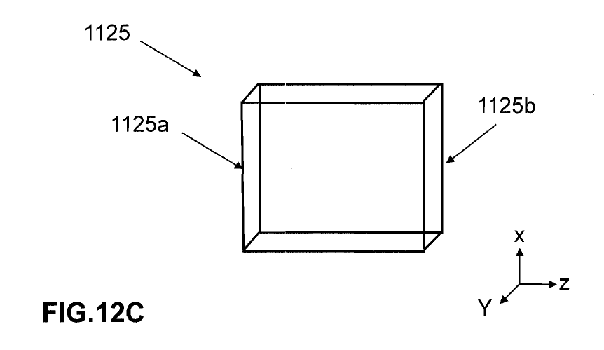

FIG. 12A is a top plan view of an exemplary edge-lit backlight apparatus 1265 for direct-view displays. Such direct-view displays include but are not limited to liquid crystal displays (LCDs), MEMS based displays manufactured by Pixtronix, Inc., and TMOS displays manufactured by UniPixel Displays, Inc. The backlight 1265 consists of a light apparatus 1200, a micro-element plate 1100, a light pipe 1110, a highly reflective layer 1111 and light guide plate 1120. Light apparatus 1200 is selected from the light sources and illumination systems of this disclosure and delivers a single color, more than one color (e.g., red, green, and blue), or white light. For example, light apparatus 1200 can deliver red, green, and blue colors sequentially and, thus, enabling a color display while eliminating the need for the panel's color filters. A micro-element plate 1100 is utilized to uniformly distribute the light beam 1152 of light apparatus 1200 along the edge of a light guide plate 1120.

FIG. 12B is an exploded perspective view of the backlight apparatus 1265 of FIG. 12A. The light guide plate 1120 is usually used in a direct view liquid crystal display (LCD) to couple light from a light source into a display panel placed on top of plate 1120. Light beam 1152 exiting light apparatus 1200 enters light pipe 1110 and travels toward the highly reflective layer 1111. Micro-element plate 1100 is attached to the front surface of light pipe 1110 as shown in FIGS. 12A-12B. However, micro-element plate 1100 can be attached to the back surface of light pipe 1110. Alternatively, the micro-elements can be made directly on the front and/or back surface of light pipe 1110 eliminating the need for a separate micro-element plate 1100.

Large number of micro-elements (e.g., micro-lenses, micro-prisms, micro-guides, micro-tunnels) formed on the surface of micro-element plate 1100 (or the surface of light pipe 1110) are used to couple light 1152 into light guide plate 1120. The coupled light enters light guide plate 1120 as light 1153 and gets extracted from light guide plate 1120 in the +Y direction toward the display panel. The micro-elements are distributed non-uniformly along micro-element plate 1100 (Z direction) and their density increases in the +Z direction. Since the light intensity decreases due to the extraction of light as it travels in the +Z direction, this type of non-uniform distribution of micro-elements leads to a uniform light distribution along the edge of a light guide plate 1120. The back end of the light pipe 1110 is preferably coated with a highly reflective layer 1111 to avoid light leakage.

Design, operation and fabrication of the micro-element plate 1100 are described in U.S. patent application Ser. Nos. 10/458,390, filed on Jun. 10, 2003 and 11/066,616, filed on Feb. 25, 2005, which is incorporated herein by reference.

FIG. 12C shows a light guide plate 1125 that can be used in backlight. In one implementation of plate 1125, a highly reflective white paint is applied to its back side 2120b. Light 1153 traveling within plate 1125 is diffused upon striking the white paint. Large portion of the diffused light ends up (and after striking the white paint many times) exiting plate 1125 through its front surface 1125a (in the +Y direction) and enters the display panel (or the brightness enhancement films which are typically placed between the display panel and light guide plate 1125 for light collimation).

The backlight may be implemented with plate 1125 that does not use white paint and instead uses micro-elements on the plate's front 1125a and/or back 1125b surfaces. These micro-elements direct light toward the display panel via reflection, total internal reflection, or diffraction. Such methods are known in the prior art. Since light sources and illumination systems of this disclosure provide polarized light with low etendue (or collimated light), using micro-elements that direct light toward the display panel in a non-diffusive manner while preserving light polarization allows the elimination of brightness enhancement films (BEFs), dual brightness enhancement films (DBEFs) and polarization films, thus, enhancing the optical efficiency of the display.

The backlight may be operated to emit red, green and blue light in sequence with one color at a time as required by the display content. The display panel controller in a color sequential system is synchronized with the backlight so that when a given color is on, only the matching pixels are turned on. This approach leads to enhanced color gamut and less power consumption. Furthermore, this approach does not require the color filters in the display panel or the color sub-pixels resulting in simpler display panels with higher resolution.

In certain configurations, the backlight has light guide plate 1125 with a lens (or micro-lens) array on its top surface. The lens (or micro-lens) array has a lens (or micro-lens) element corresponding to each pixel in the display panel. The function of each lens element in the lens (or micro-lens) array is to focus the light exiting the light guide plate 1125 into the aperture of the corresponding pixel in the display panel. Thus, eliminating or significantly reducing light absorption by the black matrix surrounding the aperture of each pixel in a display panel and leading to an enhanced optical efficiency. This approach requires alignment between the backlight and the display panel so that each lens (or micro-lens) element in the lens (or micro-lens) array is aligned with the corresponding pixel ensuring that a large portion of focused light will pass through the pixel aperture. The lens array is effective in its function due to the use of the low-etendue light sources and illumination systems of this disclosure. The low-etendue of the light source allows the collimation of the emitted light to a certain degree, thus, enabling the lens or micro-lens element to focus this light into a spot smaller or equal to the size of the pixel aperture. Backlights that utilize LEDs and CCFLs as light sources cannot effectively utilize a lens (or micro-lens) array in their architecture to enhance the optical efficiency due to the large etendue of the LED and CCFL light sources.

In certain configurations, a lens (or micro-lens) array as described herein is integrated into the display panel rather than being part of the backlight. This approach leads to better alignment between the lens (or micro-lens) array and the pixel array of the display panel. Furthermore, it eliminates the need for the alignment between the backlight and display panel.

Light pipe 1110, micro-element plate 1100, and light guide plate 1120, 1125 are made of optically transmissive materials such as glass or polymer.

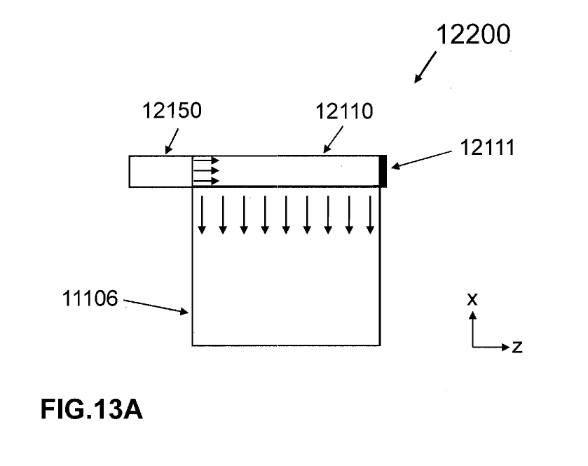

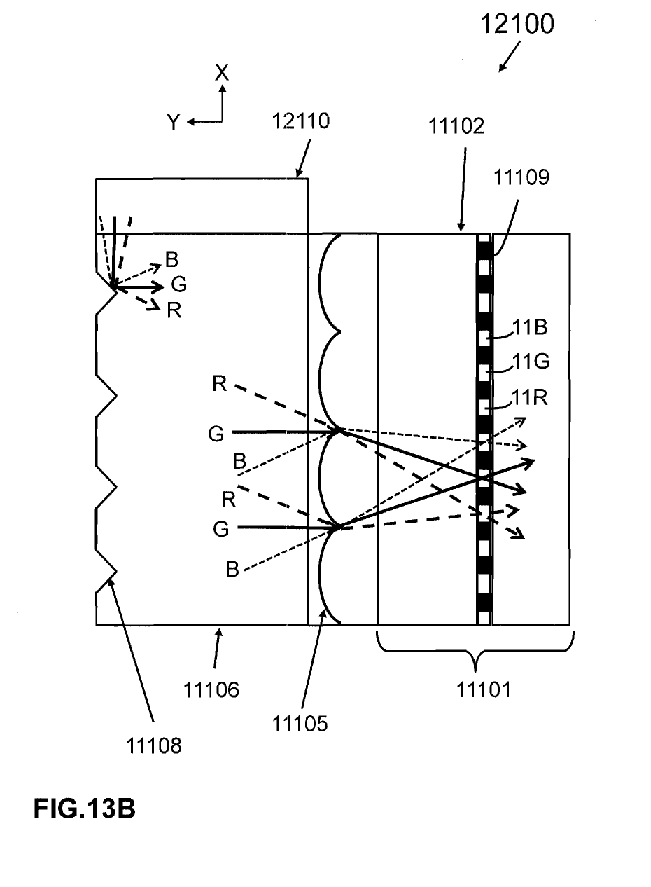

A top plan view of an edge-lit backlight apparatus 12200 that utilizes angular color separation for direct-view displays is shown in FIG. 13A. Direct-view displays that can be used with this configuration include but are not limited to liquid crystal displays (LCDs), MEMS based displays manufactured by Pixtronix, Inc., and TMOS displays manufactured by UniPixel Displays, Inc. The backlight 12200 consists of a light assembly 12150 that provides angular color separation, a light pipe 12110, a highly reflective layer 12111 and light guide plate 11106. Light assembly 12150 is selected from the light sources and illumination systems that deliver angular color separation including illumination assemblies 12010 and 12020 of FIGS. 10G and 10H.

A direct-view display system 12100 that utilizes angular color separation method to produce a full color image from a direct-view panel (e.g., LCD or MEMS based panels) is shown in FIG. 13B. In this method, red, green and blue colors are generated at separated angles. For example, red, green and blue colors can be generated at 10±5°, 0±5° and −10±5°, respectively. This method is discussed by L. C. Ling et al. in “An Efficient Illumination System for Single-Panel LCD Projector”, Society for Information Display, Symposium Digest of Technical Papers, 2001, pp. 1184-1187. This document discusses the method in relation to projection systems, however, the same discussion is useful in relation to direct-view displays. Therefore this document is incorporated herein by reference. Direct-view display system 12100 utilizes backlight apparatus 12200 of FIG. 13A. The display system 12100 consists of illumination assembly 12150 (not shown in FIG. 13B), light pipe 12110 that has extraction micro-elements integrated on its surface (not shown in FIG. 13B), light guide plate 11106 that has extraction integrated micro-elements 11108 into its bottom (and/or top) surface, direct-view LCD panel 11101, and a micro-lens (or lens) array 11105 integrated into the LCD panel 11101. Red, green and blue (R, G, and B, respectively) light exiting illumination assembly 12150 enters light pipe 12110. Integrated micro-element on the surface of light pipe 12110 are utilized to uniformly extract and direct RGB light toward the light guide plate 11106 while preserving the angular color separation. RGB light is then uniformly extracted from the light guide plate 11106 and directed toward the lens (or micro-lens) array 11105 via extraction micro-elements 11108 while preserving the angular color separation. The extraction occurs through total internal reflection or reflection. The lens array 11105 is arranged so that a single lens (or micro-lens) is placed over every set of three sub-pixels (11R, 11G and 11B). The lens function is to focus the incident red, green, and blue light into the aperture of the corresponding sub-pixel 11R, 11G and 11B while avoiding optical losses that occur due to absorption by the black matrix 11109, which typically exists in LCD panels.

Metallic reflective films used in light sources, illumination assemblies, projection systems and backlights of this disclosure are prepared by dipping the part to be coated with the metallic film in a reflection solution (e.g., mixture of silver nitrate and ammonia), removing the part from the reflection solution, and then solidifying a portion of the reflection solution that remains on the part.

Light sources, illumination systems, projection systems and backlights of this disclosure utilize violet laser diodes that are efficient, low-cost and commercially available in high volumes from many vendors (e.g., Nichia, Sony, and Sanyo). Violet semiconductor laser diodes have been developed for the optical storage application. Light sources of this disclosure bridge the gap between light emitting diodes (LEDs) and lasers by providing visible light with etendue smaller than that of LEDs and larger than that of lasers. Light sources, illumination systems, projection systems and backlights of this disclosure have the following advantages over known light sources, illumination systems, projection systems and backlights. (1) They utilize violet laser diodes (wavelength range of 405 nm±45 nm) that have the highest efficiency (output optical power divided by input electrical power) when compared to UV or blue laser diodes. Thus, light sources and illumination systems of this disclosure provide light in the visible wavelength range with higher efficiency when compared to light source and illumination systems that utilize wavelength conversion materials and lasers having their peak wavelength outside the violet wavelength range. Also, light source and illumination systems that utilize wavelength conversion materials and violet lasers are more optically efficient than light source and illumination systems that utilize UV, violet or blue LEDs due to the higher recycling efficiency of the recycling envelope when lasers are coupled through a small input aperture or through a single input-output aperture (see the earlier discussion in connection with FIGS. 2E-2F). The limited reflectivity of the UV, violet, and blue LEDs leads to significant optical losses during the recycling of the light within the recycling envelope. In addition, available violet lasers (especially, transverse multimode violet lasers) have on average comparable wall plug efficiency when compared to that of violet, UV, and blue LEDs. (2) They provide low-cost green and blue light sources that have low etendue values suitable for etendue-limited applications (e.g., miniature projectors). This advantage is significant since miniature green lasers, which can provide low etendue green light, are not commercially available yet. Furthermore, the price of the commercially available blue lasers and the projected price of the green lasers (once become commercially available) are too high for many applications (e.g., backlights for mobile displays and miniature projectors). (3) They provide an effective solution for speckle removal since the light sources and illumination systems of this disclosure emit incoherent light (e.g., red, green and blue). The speckle removal in red, green and blue lasers is a challenging problem and its removal usually leads to optical losses, increased cost and larger system size. Therefore, light sources and illumination systems of this disclosure provide an innovative solution for producing visible light (e.g., red, green and blue) that has low etendue values and is non-coherent (i.e., does not produce speckle on the screen) at low cost. (4) Miniature projection systems based on light sources and illumination systems of this disclosure have more compactness, provide more light on the screen and consume less electrical power when compared to miniature projection systems based on known light sources and illumination systems (e.g., LEDs and lamps). Low-etendue light sources and illumination systems of this disclosure enable miniature projectors with smaller micro-displays and optics, thus, reducing the size and cost of the miniature projector without significantly reducing the amount of light delivered to the screen and/or increasing the power consumption. Whereas, miniature projectors based on known light sources and illumination systems (e.g., LEDs and lamps) suffer from significant light losses due to their large etendue, thus, reducing the amount of light that can reach the screen. (5) Backlights based on light sources and illumination systems of this disclosure have higher optical efficiency and lower power consumption. In addition, they eliminate the need for color filters, brightness enhancement films, and polarizing films in direct-view LCD panels.

Certain embodiments have been described. However, various modifications to these embodiments are possible, and the principles presented herein may be applied to other embodiments as well. For example, the principles disclosed herein may be applied to devices other than those specifically described herein. In addition, the various components and/or method steps may be implemented in arrangements other than those specifically disclosed without departing from the scope of the claims.

Thus, other embodiments and modifications will occur readily to those of ordinary skill in the art in view of these teachings. Therefore, the following claims are intended to cover all such embodiments and modifications when viewed in conjunction with the above specification and accompanying drawings.

What is claimed is:

1. An illumination system, comprising:
a violet laser; and
wavelength conversion material to convert light from the violet laser from a first wavelength range to a second wavelength range.

2. The illumination system of claim 1, wherein the violet laser is a laser diode that emits light predominately in the wavelength range of 405 nm, ±45 nm.

3. The illumination system of claim 1, wherein the violet laser is a laser diode that emits light predominately in the wavelength range of 405 nm, ±25 nm.

4. The illumination system of claim 1, wherein the violet laser is a laser diode that emits light predominately in the wavelength range of 405 nm, ±10 nm.

5. The illumination system of claim 1, wherein the violet laser is a transverse multimode violet laser diode.

6. The illumination system of claim 1, further comprising a light envelope receiving light from the violet laser admitted through a single aperture of the light envelope.

7. The illumination system of claim 6, wherein the wavelength conversion material is disposed on an interior surface of the light envelope.

8. The illumination system of claim 7, wherein the wavelength conversion material is a layer covering substantially an entire interior surface of the light envelope.

9. The illumination system of claim 6, wherein the light envelope includes a three-dimensional surface that encloses an interior volume.

10. The illumination system of claim 6, further comprising a reflective coating on a surface of the light envelope.

11. The illumination system of claim 1, further comprising an optical element located in the optical path between the violet laser and the single aperture.

12. The illumination system of claim 1, further comprising a collimating optical element.

13. The illumination system of claim 12, wherein the collimating optical element is a collimating plate.

14. The illumination system of claim 1, further comprising a light guide.

15. The illumination system of claim 14, wherein the light guide includes the single aperture and is placed over an opening of the light envelope.

16. The illumination system of claim 14, further comprising a reflective coating on the light guide.

17. The illumination system of claim 1, further comprising a heat sink contacting the light envelope.

18. The illumination system of claim 1, wherein the wavelength conversion material is a phosphor material selected from the group consisting of thiogallate (TG), SrSiON:Eu, SrBaSiO:Eu, BaSrSiN:Eu, CaS:Eu, (Sr_{0.5},Ca_{0.5})S:Eu, SrS:Eu, SrSiN:Eu, YAG and any suitable combination of the foregoing.
